(19) United States
(12) Patent Application Publication
(10) Pub. No.: US 2018/0346741 A1
(43) Pub. Date: Dec. 6, 2018

(54) PRINTING FORMULATION AND APPLICATION THEREOF

(71) Applicant: GUANGZHOU CHINARAY OPTOELECTRONIC MATERIALS LTD., Science City, Guangzhou (CN)

(72) Inventors: Junyou PAN, Guangzhou (CN); Xi YANG, Guangzhou (CN); Jiahui TAN, Guangzhou (CN)

(21) Appl. No.: 15/775,392

(22) PCT Filed: Sep. 26, 2016
(86) PCT No.: PCT/CN2016/100161

§ 371 Date: May 11, 2018

(30) Foreign Application Priority Data
Nov. 12, 2015 (CN) 201510771702.4

(51) Int. Cl. C09D 11/037; C09K 11/56; C09K 11/88; C09K 11/06; C09D 5/22

(52) U.S. Cl. CPC C09D 11/037; C09K 11/565; C09K 11/883; C09K 2211/1014; C09D 5/22; C09K 2211/185; C09K 2211/1029; C09K 11/06

(57) ABSTRACT

A printing formulation and an application thereof, the printing formulation comprising a functional material and a solvent composition, wherein the solvent composition comprises a first solvent and a second solvent, the first solvent having a boiling point T1 less than a boiling point T2 of the second solvent, the first solvent having a surface tension δ1 greater than a surface tension δ2 of the second solvent, and δ1−δ2≥2 dyne/cm.

### CROSS-REFERENCE TO RELATED APPLICATIONS

The present application is the national phase of International Application No. PCT/CN2016/100161, filed on Sep. 26, 2016, which claims priority to Chinese Application No. 201510771702.4, filed on Nov. 12, 2015, both of which are incorporated herein by reference in their entireties.

### TECHNICAL FIELD

The disclosure relates to the field of organic electroluminescence technology, and in particular to a printing formulation and application thereof.

### BACKGROUND

Organic light-emitting diodes (OLEDs), as a new-generation display technology, are typically prepared by the evaporation process. Vacuum processes used in the preparation process cause low material utilization, while the fine metal mask (FMM) is required, resulting in high costs and low yield at the same time. High-resolution full-color display technology realized by using the printing process has been receiving more and more attention in seeking of solutions for the above problems. For example, ink jet printing can produce functional material films at a large area with low cost. Compared with the traditional semiconductor production processes, ink jet printing is considered as a production technology with great advantages and promising potential due to its low energy and water consumption and is environment-friendly. Another new display technology, quantum dot light emitting diode (QLED), cannot be vaporized and must be prepared by printing. Therefore, to realize a printed display, it is necessary to solve key issues in printing inks, related printing processes, and the like. Viscosity and surface tension are important parameters that affect the printing ink and the printing process. A promising printing ink needs proper viscosity and surface tension.

Due to its solution processability, organic semiconductor materials have gained widespread attention and have made remarkable progress in the application of electronic and optoelectronic devices. Solution processability allows the organic functional material to form a thin film thereof in the device through some coating and printing techniques. Such technology can effectively reduce the processing costs of electronic and optoelectronic devices, meeting the process requirements of large-area preparation. Currently, several companies have reported organic semiconductor inks for printing. For example, KATEEVA, INC disclosed an ester solvent-based organic small-molecule ink for printing OLEDs (US2015044802Al); UNIVERSAL DISPLAY CORPORATION disclosed a printable organic small-molecule material ink based on aromatic ketone or aromatic ether solvents (US 20120205637); and, SEIKO EPSON CORPORATION disclosed a printable organic polymer material ink based on a substituted benzene derivative solvent. Other examples of printing inks involving organic functional materials are: CN102408776A, CN103173060A, CN103824959A, CN1180049C, CN102124588B, US2009130296A1, US2014097406A1, and the like.

Another type of functional material that is suitable for printing is inorganic nanomaterial, particularly quantum dots. Quantum dots are nanometer-sized semiconductor materials with quantum confinement effect. When stimulated by light or electricity, the quantum dots emit fluorescence with specific energy. The color (energy) of the fluorescence is determined by the chemical composition, size and shape of the quantum dots. Therefore, by controling of quantum dot size and shape, one can effectively regulate its electrical and optical properties. At present, the application of quantum dots in full-color are being studied globally, mainly focusing in the display area. Recently, quantum dots have been rapidly developed as electroluminescent devices (QLEDs) for light-emitting layers, and the device lifetimes have been greatly improved. See, for example, such as described in Peng et al., Nature Vol 515 96 (2015) and Qian et al., Nature Photonics Vol 9 259 (2015). Currently, several companies have reported quantum dot inks for printing: Nanoco Technologies Ltd has disclosed a method for printing ink formulations containing nanoparticles (CN101878535B). Printable nanoparticle inks and corresponding nanoparticle-containing films were obtained by selecting suitable solvents such as toluene and dodecaneselenol. Samsung Electronics disclosed a quantum dot ink for ink jet printing (U.S. Pat. No. 8,765,014B2), which contains a concentrations of quantum dot materials, organic solvents and alcohol polymer additives with high viscosity. A quantum dot film was obtained by printing with the ink, and a quantum dot electroluminescent device was prepared. QD Vision Inc. disclosed a quantum dot ink formulation comprising a host material and a quantum dot material and an additive (US2010264371Al).

Other patents concerning quantum dot printing inks are: US2008277626A1, US2015079720A1, US2015075397A1, TW201340370A, US2007225402A1, US2008169753A1, US2010265307A1, US2015101665A1, and WO2008105792A2. In these published patents, these quantum dot inks contain other additives such as alcohol polymers in order to control the physical parameters of the ink. The introduction of polymer additives with insulating properties tends to reduce the charge transport capacity of the film, causing a negative impact on the optoelectronic properties of the device, and thus limits its wide application in optoelectronic devices.

In addition, the process of ink-jet printing and film-forming is often accompanied by a “coffee ring effect”, that is, the solute material is easily deposited to the edge of the liquid droplets, resulting in the appearance of a thin central surface and a thick edge of the dried film. This is because during the drying process, the solvent starts to evaporate mainly from the edge of the droplet, and the volume change of the solution occurs mainly in the center of the droplet, which in turn causes the solution to flow from the center to the edge. The resulting non-uniform thickness of the film is highly detrimental to the further processing of optoelectronic devices and device performance. Therefore, the search for a suitable solvent system to reduce the “coffee ring effect” of inkjet printing films is particularly important for improving the uniformity of the film and the performance of the device.

### SUMMARY OF THE INVENTION

In view of the above, it is an object of the present disclosure to provide a printing formulation suitable for printing.

The specific technical solution is as follows.

A printing formulation is provided herein, comprising a functional material and a solvent composition, the solvent composition comprising a first solvent and a second solvent, the first solvent having a boiling point T1 less than a boiling point T2 of the second solvent, and the first solvent having a surface tension M greater than a surface tension δ2 of the second solvent, wherein δ1−δ2≥2 dyne/cm.

In some of these embodiments, T1≥160° C. and T2−T1≥5° C.

In some of these embodiments, T1≥200° C., T2−T1≥20° C., and δ1−δ2≥4 dyne/cm.

In some of these embodiments, T1≥250° C., T2−T1≥40° C., and δ1−δ2≥6 dyne/cm.

In some of these embodiments, the first solvent comprises 50%-80% of the total mass of the solvent composition, and the second solvent comprises 20%-50% of the total mass of the solvent composition.

In some of these embodiments, the functional material comprises from 0.3% to 30% of the total mass of the printing formulation, and the solvent composition represents from 70% to 99.7% of the total mass of the printing formulation.

In some of these embodiments, both the first solvent and the second solvent have a surface tension ranging from 19 dyne/cm to 50 dyne/cm at 25° C.

In some of these embodiments, both the first solvent and the second solvent have a viscosity ranging from 1 cPs to 100 cPs at 25° C.

In some of these embodiments, the first solvent and the second solvent are each independently selected from the group consisting of aromatic compounds, heteroaromatic compounds, ester compounds, aliphatic ketones, aromatic ketones, aromatic ethers, or aliphatic ethers. .

In some of these embodiments, the first solvent and the second solvent are compounds having the following general formula:

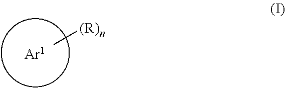

wherein Ar¹ is an aromatic or heteroaromatic ring having 5 to 10 carbon atoms, n≥1, and R is a substituent.

In some of these embodiments, the general formula I is selected from the following structures:

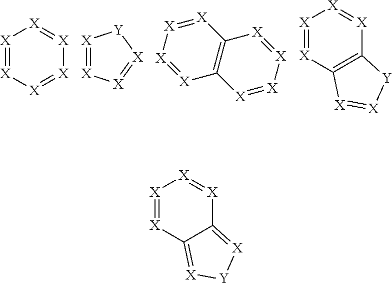

wherein X is CR¹ or N;

Y is selected from CR²R³, SiR⁴R⁵, NR⁶, C═O, S, or O;

R¹, R², R³, R⁴, R⁵, and R⁶ are each independently selected from: H; D; a linear alkyl, alkoxy, or thioalkoxy having 1 to 20 C atoms; a branched or cyclic alkyl, alkoxy or thioalkoxy group, or silyl group having 3 to 20 C atoms; a substituted ketone group having 1 to 20 C atoms; an alkoxy group having 2 to 20 C atoms; an aryloxycarbonyl having 7 to 20 C atoms, cyano, carbamoyl, haloformyl, formyl, isocyano, isocyanate, thiocyanate, or isothiocyanate, hydroxy, nitro, CF₃, Cl, Br, and F; a substituted or unsubstituted aromatic or heteroaromatic ring group having 5 to 40 annular atoms; or an aryloxy group or heteroaryloxy group having 5 to 40 annular atoms.

In some of these embodiments, Ar¹ is selected from the following structures:

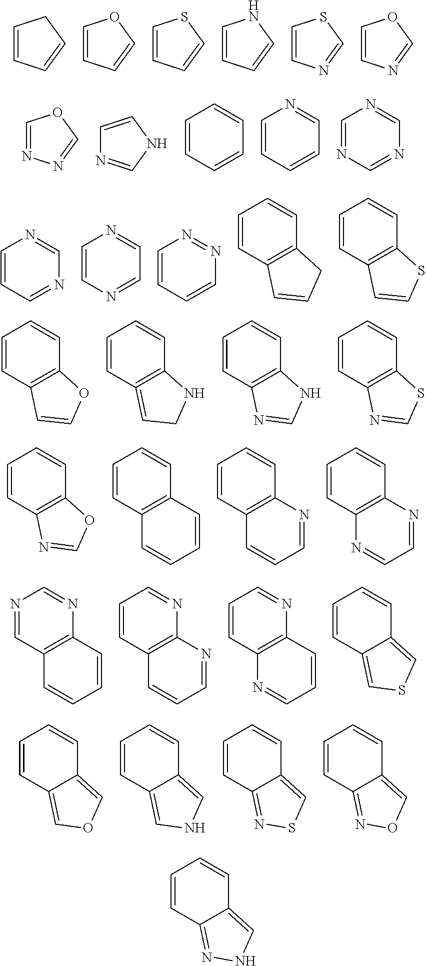

In some of these embodiments, the substituent R is selected from: a linear alkyl, alkoxy, or thioalkoxy having 1 to 20 C atoms; or a branched or cyclic alkyl, alkoxy or thioalkoxy group, or silyl group having 3 to 20 C atoms; or a substituted ketone group having 1 to 20 C atoms; an alkoxy group having 2 to 20 C atoms; or an aryloxycarbonyl having 7 to 20 C atoms, cyano, carbamoyl, haloformyl, formyl, isocyano, isocyanate, thiocyanate, or isothiocyanate, hydroxy, nitro, CF₃, Cl, Br, and F; or a substituted or unsubstituted aromatic or heteroaromatic ring group having 5 to 40 annular atoms; or an aryloxy group or heteroaryloxy group having 5 to 40 annular atoms.

In some of these embodiments, the first solvent and the second solvent are each independently selected from: dodecylbenzene, dipentylbenzene, diethylbenzene, trimethylbenzene, tetramethylbenzene, tripentylbenzene, pentyltoluene, 1-methylnaphthalene, dihexylbenzene, dibutylbenzene, p-diisopropylbenzene, phenylpentane, tetrahydronaphthalene, cyclohexylbenzene, chloronaphthalene, 1-tetralone, 3-phenoxytoluene, 1-methoxynaphthalene, cyclohexylbenzene, dimethylnaphthalene, 3-isopropylbiphenyl, p-methylcumyl, benzyl benzoate, dibenzyl ether or benzyl benzoate.

In some of these embodiments, the first solvent and the second solvent are each independently selected from: alkyl octoates, alkyl sebacates, alkyl stearates, alkyl benzoates, alkyl phenylacetates, alkyl cinnamates, alkyl oxalates, alkyl maleates, alkyl lactones, alkyl oleates, dioctyl ether, triethylene glycol dimethyl ether, fenone, 2,6,8-trimethyl-4-nonanone, acetophenone, benzophenone, butoxybenzene, benzyl butylbenzene or 2,5-dimethoxytoluene.

In some of these embodiments, the functional material is an inorganic nanomaterial or an organic functional material.

In some of the embodiments, the inorganic nanomaterial is a light emitting quantum dot material, and the light emitting quantum dot material has an emission wavelength between 380 nm and 2500 nm.

In some of these embodiments, the inorganic nanomaterial is selected from binary or polybasic semiconductor compounds of Group IV, II-VI, II-V, III-V, IV-VI, II-IV-VI, and II-IV-V of the periodic table, or a mixture of these compounds.

In some of these embodiments, the organic functional material is selected from hole injection materials, hole transport materials, electron transport materials, electron injection materials, electron blocking materials, hole blocking materials, emitters, host materials, and organic dyes.

In some of these embodiments, the organic functional material includes at least one host material and at least one emitter material.

Another object of the present disclosure is to provide the use of the printing formulation described above.

The specific technical solution is as follows.

Use of the above printed formulation in the preparation of electronic devices is provided herein.

Another object of the present disclosure is to provide an electronic device.

The specific technical solution is as follows.

An electronic device using the above printing formulation to prepare a functional film is provided herein.

In some of these embodiments, the method for preparing the functional film includes the following steps: coating the printing formulation on a substrate.

In some of these embodiments, the coating method is selected from the group consisting of ink-jet printing, nozzle printing, typography, screen printing, dip coating, spin coating, blade coating, roll printing, torsion printing, lithography, flexography, rotary printing, spray printing, brush coating, pad printing, or slit type extrusion coating.

In some embodiments, the organic electroluminescent device is selected from the group consisting of quantum dot light emitting diodes, quantum dot photovoltaic cells, quantum dot light emitting electrochemical cells, quantum dot field effect transistors, quantum dot light emitting field effect transistors, quantum dot lasers, quantum dot sensors, organic light-emitting diodes, organic photovoltaic cells, organic light-emitting electrochemical cells, organic field effect transistors, organic light-emitting field effect transistors, organic lasers, and organic sensors.

The above printing formulation comprises at least one functional material and at least two organic solvents, wherein the boiling point of at least one of the solvents is ≥160° C., the surface tension difference of the two organic solvents is at least 2 dyne/cm, and one of the solvents has a higher boiling point and a lower surface tension than the other solvent. In some exemplary embodiments, the two organic solvents both have a viscosity in the range of 1 cPs to 100 cPs at 25° C., a surface tension in the range of 19 dyne/cm to 50 dyne/cm at 25° C., and a boiling point higher than 160° C. The above technical solution also relates to the printing process of this formulation and its application in electronic devices, especially in electroluminescent devices. The printing formulation of the present disclosure can have its viscosity and surface tension adjusted to a suitable range according to a specific printing method, particularly ink jet printing, to facilitate printing, so as to form a film having a uniform surface (and the coffee ring effect can be eliminated). At the same time, the organic solvent can be effectively removed by post-treatment, such as heat treatment or vacuum treatment, which can ensure the performance of the electronic device. The present disclosure therefore provides an ink for the preparation of high quality functional films, in particular printing inks comprising quantum dots and organic semiconductor materials, providing technical solutions for printing electronic or optoelectronic devices.

### BRIEF DESCRIPTION OF DRAWINGS

FIG. 1 is a structural diagram of a light emitting device according to an embodiment of the present disclosure, wherein 101 is a substrate, 102 is an anode, 103 is a hole injection layer (HIL) or a hole transport layer (HTL), 104 is a light emitting layer (electroluminescent device) or light absorbing layer (photovoltaic cell), 105 is an electron injection layer (EIL) or electron transport layer (ETL), and 106 is a cathode.

### DETAILED DESCRIPTION OF EMBODIMENTS

To facilitate understanding of the present disclosure, the present disclosure will be described in further details hereinafter with reference to the accompanying drawings. The exemplary embodiments of the disclosure are given in the accompanying drawings. However, the present disclosure may be embodied in many different forms and is not limited to the embodiments described herein. Rather, these embodiments are provided so that this disclosure will be understood thoroughly and comprehensively.

Unless otherwise defined, all technical and scientific terms used herein have the same meaning as commonly understood by one of ordinary skill in the art to which this disclosure belongs. The terminology used in the description of the present disclosure herein is for the purpose of describing particular embodiments only and is not intended to limit the present disclosure. As used herein, the term “and/or” includes any and all combinations of one or more of the associated listed items.

In the present disclosure, the printing formulation and the printing ink, or ink, have the same meaning and they are interchangeable.

The disclosure provides a printing formulation comprising at least one functional material and at least two organic solvents (a first solvent and a second solvent), wherein a boiling point T1 of the first solvent is less than a boiling point T2 of the second solvent, The surface tension M of the first solvent is greater than the surface tension δ2 of the second solvent, and δ1−67 2≥2 dyne/cm, T1≥160° C. Two organic solvents can be evaporated from the solvent system to form a thin film containing the functional material.

In certain embodiments, the boiling point of at least one of the two organic solvents is ≥180° C. In some embodiments, the boiling point of at least one of the two organic solvents is ≥200° . C. In some exemplary embodiments, the boiling point of at least one of the two organic solvents is 225° C. In other exemplary embodiments, the boiling point of at least one of the two organic solvents is ≥250° C. or ≥275° C. In certain embodiments, the boiling point of at least one of the two organic solvents is ≥300° C.

In certain embodiments, the boiling points of the two organic solvents are both ≥160° C. In some exemplary embodiments, the boiling points of the two organic solvents are both ≥180° C. In other exemplary implementations, the boiling points of the two organic solvents are both ≥200° C. In other more exemplary embodiments, the boiling points of the two organic solvents are both ≥250° C. or 275° C. In some implementations, the boiling points of the two organic solvents are even both ≥300° C.

Boiling points in these ranges are beneficial for preventing nozzle clogging of inkjet print heads.

In some exemplary embodiments, the formulation according to the present disclosure comprises at least two organic solvents having a surface tension in the range of 19 dyne/cm to 50 dyne/cm at 25° C.

The surface tension parameters of a suitable printing formulation are suitable for a particular substrate and a particular printing method. For example, for ink jet printing, in an exemplary embodiment, the surface tension of the two organic solvents at 25° C. is in the range of about 19 dyne/cm to 50 dyne/cm. In another exemplary embodiment the two organic solvents have a surface tension at 25° C. in the range of 22 dyne/cm to 35 dyne/cm. In another exemplary embodiment, the two organic solvents have a surface tension at 25° C. in the range of 25 dyne/cm to 33 dyne/cm.

In an exemplary embodiment, the surface tension at 25° C. of the formulation according to the present disclosure is in the range of about 19 dyne/cm to 50 dyne/cm.,In another embodiment, in the range of 22 dyne/cm to 35 dyne/cm.,In one embodiment in the range from 25 dyne/cm to 33 dyne/cm.

In some exemplary embodiments, the formulations according to the present disclosure comprise at least two organic solvents having a viscosity at 25° C. in the range of 1 cPs to 100 cPs.

In an exemplary embodiment, the viscosity of the at least two organic solvents is less than 100 cps. In some exemplary embodiment, the viscosity of the at least two organic solvents is less than 50 cps. In another exemplary embodiment, the viscosity of the at least two organic solvents is 1.5 to 20 cps.

Viscosity can also be adjusted by the concentration of functional material in the formulation. The solvent system comprising at least two organic solvents according to the present disclosure can facilitate the adjustment of the printing ink in an appropriate range according to the printing method used. Generally, the formulation according to the present disclosure comprises the functional material in a weight ratio in the range of 0.3% to 30 wt %. In one embodiment, the formulation according to the present disclosure comprises the functional material in a weight ratio in the range of 0.5% to 20 wt %In another embodiment, the formulation according to the present disclosure comprises the functional material in a weight ratio in the range of 0.5% to 15 wt %. In yet another embodiment, the formulation according to the present disclosure comprises the functional material in a weight ratio in the range of 0.5%-10wt %.

In an exemplary embodiment, the printing formulation according to the present disclosure has a viscosity at 25° C. in the range of about 1 cps to 100 cps at the above ratio; in another embodiment, the printing formulation according to the present disclosure has a viscosity at 25° C. in the range of 1 cps to 50 cp; and in yet another embodiment, the printing formulation according to the present disclosure has a viscosity at 25° C. in the range of 1.5 cps to 20 cps. The viscosity here refers to the viscosity at the ambient temperature at the time of printing, generally at 15-30° C., In one embodiment, the viscosity here refers to the viscosity at the ambient temperature at the time of printing at 18-28° C.; in another embodiment, the viscosity here refers to the viscosity at the ambient temperature at the time of printing at 20-25° C.; and in yet another embodiment, the viscosity here refers to the viscosity at the ambient temperature at the time of printing at 23-25° C. The printing formulation thus prepared will be particularly suitable for ink jet printing.

A formulation obtained from a solvent system comprising at least two organic solvents satisfying the above-mentioned boiling point, surface tension parameters and viscosity parameters can facilitate the formation of a functional material film having a uniform thickness and compositional properties.

In an exemplary embodiment, the printing formulation comprises at least two organic solvents, wherein the first solvent accounts for 50%-80% of the total weight of the solvent, and the second solvent accounts for 20%-50% of the total weight of the solvent, wherein the second solvent has a higher boiling point and a lower surface tension than the first solvent.

The present disclosure uses a dual solvent system to formulate printing inks of functional materials. In an exemplary embodiment, a solvent with good solubility for the functional material is selected as the first solvent, wherein the good solubility ensures good dispersion and high stability of the functional material in the solution. The first solvent serves as the main body of the dual solvent system and accounts for 50% to 80% of the total amount of the solvent. In one embodiment, the first solvent accounts for more than 50% of the total amount of the solvent; in another embodiment, the first solvent accounts for more than 60% of the total amount of the solvent; and in yet another embodiment, the first solvent accounts for more than 70% of the total amount of the solvent. The first solvent has a relatively high boiling point, which is beneficial for preventing nozzle clogging of the inkjet print head while ensuring the stability of the ejection process. Then, a second solvent is selected, which has a higher boiling point and a lower surface tension than the first solvent. The second solvent accounts for 20% to 50% of the total weight of the solvent. In one embodiment, the second solvent comprises less than 50% of the total weight of the solvent; in another embodiment, the second solvent comprises less than 40% of the total weight of the solvent; and in yet another embodiment, the second solvent comprises less than 30% of the total weight of the solvent. After the ink is sprayed onto the substrate, a tendency of increasing surface tension from the edge to the center may be formed on the surface of the solution droplet during the drying process, thereby driving the surface solution to flow from the edge to the center. This forms an annular convection with the flow from the center to the edge inside the solution. Such annular convection is beneficial to the uniform distribution of functional materials in the drying process, can effectively reduce the deposition of functional materials at the edges, weaken the “coffee ring effect”, and allow the dried functional material film to have good uniformity and flatness. In certain embodiments, the second solvent has a boiling point at least 5° C. higher. In one embodiment, the second solvent has a boiling point at least 10° C. higher; in another embodiment, the second solvent has a boiling point at least 20° C. higher; and in yet another embodiment, the second solvent has a boiling point at least 30° C. higher; and in an embodiment, the second solvent has a boiling point at least 40° C. higher, than the first solvent.

In order to achieve the above-mentioned annular convection, the difference in surface tension of the two organic solvents is at least 2 dyne/cm. In an exemplary embodiment, the difference in surface tension of the two organic solvents is at least 3 dyne/cm. In a more perfered embodiment, the two organic solvents have a surface tension difference of at least 4 dyne/cm. In another exemplary embodiment, the two organic solvents have a surface tension difference of at least 5 dyne/cm. In an exemplary embodiment, the difference in surface tension between the two organic solvents is at least 6 dyne/cm.

In an exemplary embodiment, at least one of the two organic solvents comprised in the printing formulation of the present disclosure is based on aromatic or heteroaromatic solvents.

In another exemplary embodiment, the formulation according to the disclosure comprises at least two organic solvents, and at least one of the organic solvents has the general formula as below:

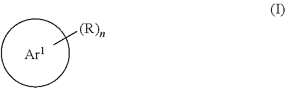

wherein,

Ar¹ is an aromatic or heteroaromatic ring having 5 to 10 carbon atoms, n≥1, and R is a substituent.

In some exemplary embodiments, the organic solvent according to formula (I) wherein Ar¹ is an aromatic or heteroaromatic ring having 5 to 10 carbon atoms. An aromatic group refers to a hydrocarbyl containing at least one aromatic ring, including monocyclic groups and polycyclic ring systems. Heteroaromatic groups refer to hydrocarbyl groups (containing heteroatoms) that contain at least one heteroaromatic ring, including monocyclic groups and polycyclic ring systems. These polycyclic rings may have two or more rings in which two carbon atoms are shared by two adjacent rings, i.e., a fused ring. At least one of these polycyclic rings is aromatic or heteroaromatic.

Specifically, examples of the aromatic group include benzene, naphthalene, anthracene, phenanthrene, perylene, tetracene, pyrene, benzopyrene, triphenylene, acenaphthene, fluorene, and derivatives thereof.

Specifically, examples of heteroaromatic groups are: furan, benzofuran, thiophene, benzothiophene, pyrrole, pyrazole, triazole, imidazole, oxazole, oxadiazole, thiazole, tetrazole, indole, carbazole, pyrroloimidazole, pyrrolopyrrole, thienopyrrole, thienothiophene, furopyrrole, furofuran, thienofuran, benzisoxazole, benzisothiazole, benzimidazole, pyridine, pyrazine, pyridazine, pyrimidine, triazine, quinoline, isoquinoline, o-diazonaphthalene, quinoxaline, phenanthridine, primidine, quinazoline, quinazolinone, and derivatives thereof

In some exemplary embodiments, the formulation comprises an organic solvent having the general formula (I), more exemplary examples of which may be further represented by the following general formula:

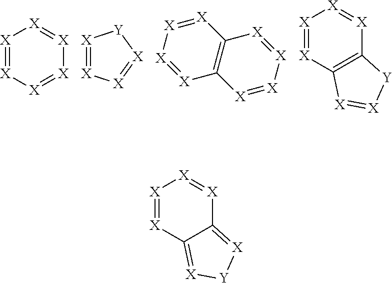

wherein X is CR¹ or N;

Y is selected from CR²R³, SiR⁴R⁵, NR⁶ or, C(═O), S, or O; and

R¹, R², R³, R⁴, R⁵,l and R⁶ are each H; D; or a linear alkyl, alkoxy, or thioalkoxy having 1 to 20 C atoms; or a branched or cyclic alkyl, alkoxy or thioalkoxy group, or silyl group having 3 to 20 C atoms; or a substituted ketone group having 1 to 20 C atoms; or an alkoxy group having 2 to 20 C atoms; or an aryloxycarbonyl having 7 to 20 C atoms, cyano (−CN), carbamoyl(—C(═O)NH₂), haloformyl (—C(═O)—X, wherein X represents a halogen atom), formyl (—C(═O)—H), isocyano, isocyanate, thiocyanate, or isothiocyanate, hydroxy, nitro, CF₃, Cl, Br, and F; a crosslinkable group or a substituted or unsubstituted aromatic or heteroaromatic ring system having 5 to 40 annular atoms; or an aryloxy group or heteroaryloxy group having 5 to 40 annular atoms, or a combination thereof, wherein one or more of the groups R¹, R², R³, R⁴, R⁵, and R⁶ may form a monocyclic or polycyclic aliphatic or aromatic ring system with each other and/or with a ring bonded to said groups.

In some exemplary embodiments, R¹, R², R³, R⁴, R⁵, and R⁶ are each H; D; or a linear alkyl, alkoxy, or thioalkoxy having 1 to 10 C atoms; or a branched or cyclic alkyl, alkoxy or thioalkoxy group, or silyl group having 3 to 10 C atoms; or a substituted ketone group having 1 to 20 C atoms; or an alkoxy group having 2 to 10 C atoms; or an aryloxycarbonyl having 7 to 10 C atoms, cyano (—CN), carbamoyl(—C(═O)NH₂), haloformyl (—C(═O)—X, wherein X represents a halogen atom), formyl (—C(═O)—H), isocyano, isocyanate, thiocyanate, or isothiocyanate, hydroxy, nitro, CF₃, Cl, Br, and F; a crosslinkable group or a substituted or unsubstituted aromatic or heteroaromatic ring system having 5 to 20 annular atoms; or an aryloxy group or heteroaryloxy group having 5 to 20 annular atoms, or a combination thereof, wherein one or more of the groups R¹, R², R³, R⁴, R⁵, and R⁶ may form a monocyclic or polycyclic aliphatic or aromatic ring system with each other and/or with a ring bonded to said groups.

In some of the other exemplary embodiments, Ar¹ in formula (I) is selected from the following structural units:

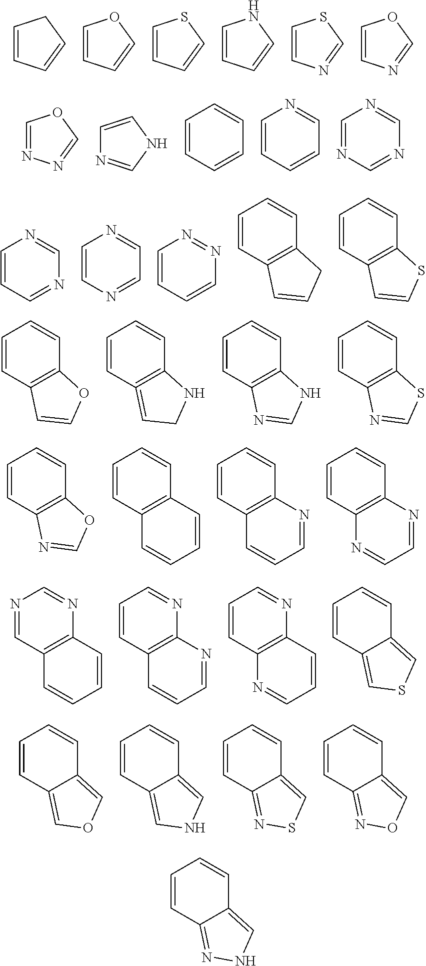

In certain embodiments, at least one substituent R in formula (I) is selected from a linear alkyl, alkoxy, or thioalkoxy having 1 to 20 C atoms; or a branched or cyclic alkyl, alkoxy or thioalkoxy group, or silyl group having 3 to 20 C atoms; or a substituted ketone group having 1 to 20 C atoms; or an alkoxy group having 2 to 20 C atoms; or an aryloxycarbonyl having 7 to 20 C atoms, cyano (—CN), carbamoyl(—C(═O)NH₂), haloformyl (—C(═O)—X, wherein X represents a halogen atom), formyl (—C(═O)—H), isocyano, isocyanate, thiocyanate, or isothiocyanate, hydroxy, nitro, CF₃, Cl, Br, and F; a crosslinkable group or a substituted or unsubstituted aromatic or heteroaromatic ring system having 5 to 40 annular atoms; or an aryloxy group or heteroaryloxy group having 5 to 40 annular atoms, or a combination thereof, wherein one or more of the group R may form a monocyclic or polycyclic aliphatic or aromatic ring system with each other and/or with a ring bonded to said groups .

In some exemplary embodiments, at least one substituent R in formula (I) is selected from a linear alkyl, alkoxy, or thioalkoxy having 1 to 10 C atoms; or a branched or cyclic alkyl, alkoxy or thioalkoxy group, or silyl group having 3 to 10 C atoms; or a substituted ketone group having 1 to 20 C atoms; or an alkoxy group having 2 to 10 C atoms; or an aryloxycarbonyl having 7 to 10 C atoms, cyano (-CN), carbamoyl(—C(═O)NH₂), haloformyl (—C(═O)—X, wherein X represents a halogen atom), formyl (—C(═O)—H), isocyano, isocyanate, thiocyanate, or isothiocyanate, hydroxy, nitro, CF₃, Cl, Br, and F; a crosslinkable group or a substituted or unsubstituted aromatic or heteroaromatic ring system having 5 to 20 annular atoms; or an aryloxy group or heteroaryloxy group having 5 to 20 annular atoms, or a combination thereof, wherein one or more of the group R may form a monocyclic or polycyclic aliphatic or aromatic ring system with each other and/or with a ring bonded to said groups.

Examples of aromatic or heteroaromatic solvents that can be used in the formulations according to the disclosure are, but not limited to, p-diisopropylbenzene, phenylpentane, tetrahydronaphthalene, cyclohexylbenzene, chloronaphthalene, 1,4-dimethyl naphthalene, 3-isopropyl biphenyl, p-methyl cumene, dipentylbenzene, o-diethylbenzene, m-diethylbenzene, p-diethylbenzene, 1,2,3,4-tetramethylbenzene, 1,2,3,5-tetramethylbenzene, 1,2,4,5 -tetramethylbenzene, butylbenzene, dodecylbenzene, 1-methylnaphthalene, 1,2,4-trichlorobenzene, 1,3-dipropoxybenzene, 4,4-difluorodiphenylmethane, 1,2-dimethoxy-4-(1-propenyl)benzene, diphenylmethane, 2-phenylpyridine, 3-phenyl pyridine, N-methyldiphenylamine, 4-isopropylbiphenyl, α,α-dichlorodiphenylmethane, 4-(3-phenylpropyl)pyridine, benzyl benzoate, 1,1-bis(3,4-dimethylphenyl) ethane, 2-isopropylnaphthalene, dibenzyl ether, and the like.

In an exemplary embodiment, the printing formulation comprises two organic solvents, at least one of which is based on an aromatic ketone organic solvent.

In certain embodiments, the aromatic ketone solvent is a tetralone, wherein examples of tetralonones include 1-tetralone and 2-tetralone.

In some other examples, the tetralone solvent comprises derivatives of 1-tetralone and 2-tetralone, i.e., tetralone substituted with at least one substituent. These substituents include aliphatic, aryl, heteroaryl, halogen and the like. Specific examples are 2-(phenylepoxy) tetralone and 6-(methoxy) tetralone.

In some other examples, the solvent of the aromatic ketone may be selected from the group consisting of acetophenone, phenyl acetone, benzophenone, and the derivatives thereof, such as 4-methyl acetophenone, 3-methyl acetophenone, 2-methyl acetophenone, 4-methyl propiophenone, 3-methyl propiophenone, and 2-methyl propiophenone.

In other embodiments, the formulation comprises two organic solvents, at least one of which is a ketone solvent containing no aromatic or heteroaromatic groups, examples of these solvents are: isophorone, 2, 6, 8-trimethyl-4- nonanone, camphor, and fenchone.

In another exemplary embodiment, at least one of the two organic solvents comprised in the formulation is an aromatic ether-based organic solvent.

The aromatic ether solvents suitable for use in the present disclosure are: 3-phenoxy toluene, butoxybenzene, benzyl butyl benzene, p-anisaldehyde dimethyl acetal, tetrahydro-2-phenoxy-2H-pyran, 1,2-dimethoxy-4-(1-propenyl) benzene, 1,4-benzodioxane, 1,3-dipropylbenzene, 2,5-dimethoxytoluene, 4-ethylbenzene ether, 1,2,4-trimethoxybenzene, 4-(1-propenyl)-1,2-dimethoxybenzene, 1,3-dimethoxybenzene, glycidyl phenyl ether, dibenzyl ether, 4-tert-butylanisole, trans-p-propenyl anisole, 1,2-dimethoxybenzene, 1-methoxynaphthalene, diphenyl ether, 2-benzene alkyl ether, 2-phenoxytetrahydrofuran, ethyl-2-naphthyl ether.

In an exemplary embodiment, the aromatic ether solvent is 3-phenoxytoluene as shown below:

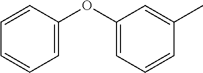

In another exemplary embodiment, the formulation comprises the two organic solvents, at least one of which is an ester-based organic solvent.

Possible ester solvents suitable for use in the present disclosure include: alkyl octoates, alkyl sebacates, alkyl stearates, alkyl benzoates, alkyl phenylacetates, alkyl cinnamate, alkyl oxalates, and maleates, alkyl lactones, alkyl oleates, and the like.

In some exemplary embodiments, the ester solvent suitable for use in the present disclosure is octyl caprylate or diethyl sebacate.

In some exemplary embodiments, a formulation according to the present disclosure comprises two organic solvents, at least one of which is selected from aliphatic ketones or aliphatic ethers.

In some exemplary embodiments, the organic solvent of the aliphatic ketone may be selected from the group consisting of 2-nonanone, 3-nonanone, 5-nonanone, 2-decanone, 2,5-hexanedione, 2,6,8-trimethyl-4-nonanone, fenone, di-n-amyl ketone, and the like.

In some other exemplary embodiments, the organic solvent of the aliphatic ether may be selected from pentyl ether, hexyl ether, dioctyl ether, ethylene glycol dibutyl ether, diethylene glycol diethyl ether, diethylene glycol butyl ether, diethylene glycol dibutyl ether, triethylene glycol dimethyl ether, triethylene glycol ethyl methyl ether, triethylene glycol butyl methyl ether, tripropylene glycol dimethyl ether, tetraethylene glycol dimethyl ether, and the like.

The solvent system based on the two organic solvents can effectively disperse the functional materials, i.e., as a new dispersion solvent to replace the traditionally used solvent for the dispersion of functional materials, such as toluene, xylene, chloroform, chlorobenzene, dichlorobenzene, heptanes, and the like.

The boiling point, surface tension, and viscosity parameters for some of the above solvent examples are listed below:

| | | Boiling | Surface | Viscosity |
|---|---|---|---|---|
| | | Point | Tension@RT | @RT |
| Name | Structural Formula | (° C.) | (dyne/cm) | (cPs) |
| 1-tetralone | 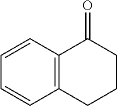 [SMILES: O=C1CCCc2ccccc21] | 256 | 42 | 8.6 |
| 3-phenoxytoluene | 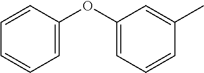 | 272 | 37.4 | 5 |
| acetophenone | 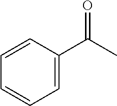 | 202 | 39 | 1.6 |
| 1-methoxy- naphthalene | 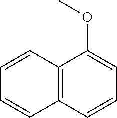 | 270 | 43 | 7.2 |
| p-diisopropyl benzene | 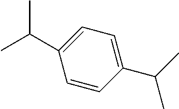 | 210 | 28.3 | 1.2 |
| phenylpentane | 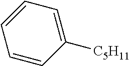 | 205 | 30.4 | 1.3 |
| tetrahydro- naphthalene | 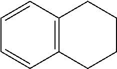 | 207 | 35.9 | 2 |
| cyclohexyl- benzene | 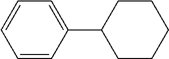 [SMILES: c1ccc(C2CCCCC2)cc1] | 238 | 34 | 4 |
| chloronaphthalene | 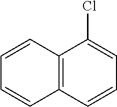 [SMILES: Clc1cccc2ccccc12] | 260 | 43 | 3 |
| 1,4-dimethyl naphthalene | 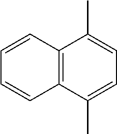 | 268 | 40 | 6 |
| 3-isopropyl biphenyl | 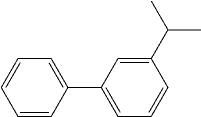 | 296 | 34 | 9 |
| p-methyl cumene | 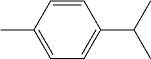 | 177 | 28.8 | 3.4 |
| dipentylbenzene | 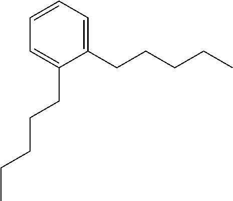 [SMILES: CCCCCc1ccccc1CCCCC] | 255-280 | 30 | 4.7 |
| o-diethylbenzene | 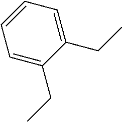 | 183 | 30 | 3.8 |
| m-diethylbenzene | 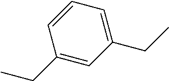 | 181 | 29 | 1.24 |
| p-diethylbenzene | 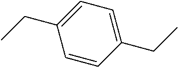 | 183 | 29 | 3.6 |
| 1,2,3,4-tetra- methylbenzene | 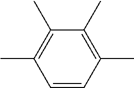 | 205 | 29 | 2 |
| 1,2,3,5-tetra- methylbenzene | 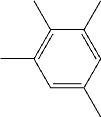 | 205 | 29 | 2 |
| 1,2,4,5-tetra- methylbenzene | 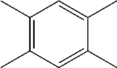 | 197 | 29 | 2 |
| butylbenzene | 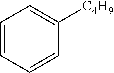 | 183 | 29.23 | 1 |
| dodecylbenzene | 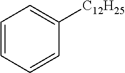 | 331 | 30.12 | 5.4 |
| 1-methyl- naphthalene | 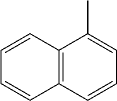 | 240 | 38 | 3 |
| 1,2,4-trichloro- benzene | 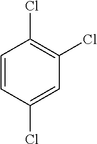 | 214 | 31 | 1.6 |
| diphenyl ether | 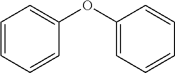 [SMILES: c1ccc(Oc2ccccc2)cc1] | 257 | 38 | 3.5 |
| diphenylmethane | 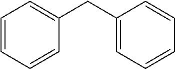 [SMILES: c1ccc(Cc2ccccc2)cc1] | 265 | 37 | 1.5 |
| 4-isopropyl- biphenyl | 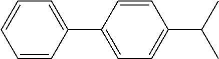 | 298 | 34 | 9 |
| benzyl benzoate | 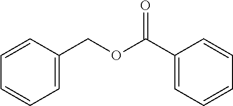 [SMILES: O=C(OCc1ccccc1)c1ccccc1] | 324 | 44 | 8.3 |
| 1,1-bis(3,4- dimethylphenyl) ethane | 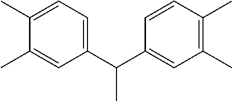 | 333 | 34 | 10 |
| 2-isopropyl- naphthalene | 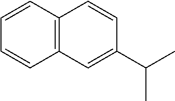 | 268 | 36 | 4 |
| dibenzyl ether | 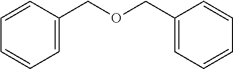 [SMILES: c1ccc(COCc2ccccc2)cc1] | 298 | 39 | 8.7 |
| octyl caprylate | 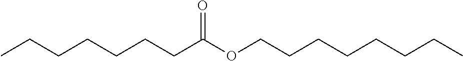 [SMILES: CCCCCCCCOC(=O)CCCCCCC] | 307 | 30.1 | 4.56 |
| diethyl sebacate | 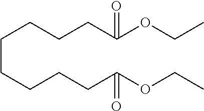 [SMILES: CCOC(=O)CCCCCCCCC(=O)OCC] | 312 | 32.9 | 6 |
| diallyl phthalate | 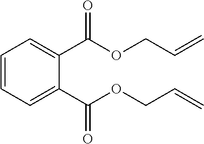 [SMILES: C=CCOC(=O)c1ccccc1C(=O)OCC=C] | 290 | 39.2 | 9~13 |
| isononyl isononanoate | 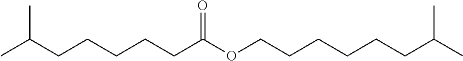 [SMILES: CC(C)CCCCCCOC(=O)CCCCCC(C)C] | 285 | 27.8 | 7 |

Examples of dual solvent systems suitable for the present disclosure are, but not limited to:

| The First Solvent | The Second Solvent | Weight Ratio |
|---|---|---|
| 1-tetralone | 3-phenoxytoluene | 50:50~80:20 |
| | 1,4-dimethyl naphthalene | 50:50~80:20 |
| | 3-isopropyl biphenyl | 50:50~80:20 |
| | dodecylbenzene | 50:50~80:20 |
| | 4-isopropyl biphenyl | 50:50~80:20 |
| | 1,1-bis(3,4-dimethylphenyl) | 50:50~80:20 |
| | ethane | |
| | 2-isopropylnaphthalene | 50:50~80:20 |
| | dibenzyl ether | 50:50~80:20 |
| | octyl caprylate | 50:50~80:20 |
| | diethyl sebacate | 50:50~80:20 |
| | diallyl phthalate | 50:50~80:20 |
| | isononyl isononanoate | 50:50~80:20 |
| 3-phenoxytoluene | 3-isopropyl biphenyl | 50:50~80:20 |
| | dodecylbenzene | 50:50~80:20 |
| | 4-isopropyl biphenyl | 50:50~80:20 |
| | 1,1-bis(3,4-dimethylphenyl) | 50:50~80:20 |
| | ethane | |
| | octyl caprylate | 50:50~80:20 |
| | diethyl sebacate | 50:50~80:20 |
| | isononyl isononanoate | 50:50~80:20 |
| cyclohexylbenzene | dodecylbenzene | 50:50~80:20 |
| | octyl caprylate | 50:50~80:20 |
| | isononyl isononanoate | 50:50~80:20 |
| 3-isopropyl biphenyl | dodecylbenzene | 50:50~80:20 |
| | octyl caprylate | 50:50~80:20 |
| 1-methylnaphthalene | 3-isopropyl biphenyl | 50:50~80:20 |
| | dodecylbenzene | 50:50~80:20 |
| | 4-isopropyl biphenyl | 50:50~80:20 |
| | 1,1-bis(3,4-dimethylphenyl) | 50:50~80:20 |
| | ethane | |
| | 2-isopropylnaphthalene | 50:50~80:20 |
| | octyl caprylate | 50:50~80:20 |
| | diethyl sebacate | 50:50~80:20 |
| | isononyl isononanoate | 50:50~80:20 |
| diphenyl ether | 3-isopropyl biphenyl | 50:50~80:20 |
| | dodecylbenzene | 50:50~80:20 |
| | 4-isopropyl biphenyl | 50:50~80:20 |
| | 1,1-bis(3,4-dimethylphenyl) | 50:50~80:20 |
| | ethane | |
| | 2-isopropylnaphthalene | 50:50~80:20 |
| | octyl caprylate | 50:50~80:20 |
| | diethyl sebacate | 50:50~80:20 |
| | isononyl isononanoate | 50:50~80:20 |
| 2-isopropylnaphthalene | 3-isopropyl biphenyl | 50:50~80:20 |
| | 4-isopropyl biphenyl | 50:50~80:20 |
| | 1,1-bis(3,4-dimethylphenyl) | 50:50~80:20 |
| | ethane | |
| | octyl caprylate | 50:50~80:20 |
| | diethyl sebacate | 50:50~80:20 |
| | isononyl isononanoate | 50:50~80:20 |
| dibenzyl ether | dodecylbenzene | 50:50~80:20 |
| | 1,1-bis(3,4-dimethylphenyl) | 50:50~80:20 |
| | ethane | |
| | octyl caprylate | 50:50~80:20 |
| | diethyl sebacate | 50:50~80:20 |
| diallyl phthalate | dodecylbenzene | 50:50~80:20 |
| | 1,1-bis(3,4-dimethylphenyl) | 50:50~80:20 |
| | ethane | |
| | octyl caprylate | 50:50~80:20 |
| | diethyl sebacate | 50:50~80:20 |

In some other examples, the formulation comprising two organic solvents further comprises another organic solvent. Examples of such other organic solvents include, but are not limited to, methanol, ethanol, 2-methoxyethanol, methylene chloride, chloroform, chlorobenzene, o-dichlorobenzene, tetrahydrofuran, anisole, morpholine, toluene, o-xylene, m-xylene, p-xylene, 1,4-dioxane, acetone, methyl ethyl ketone, 1,2-dichloroethane, 3-phenoxy toluene, 1,1,1-trichloroethane, 1,1,2,2-tetrachloroethane, ethyl acetate, butyl acetate, dimethylformamide, dimethylacetamide, dimethyl sulfoxide, tetrahydronaphthalene, decalin, indene, and/or mixtures thereof.

The printing ink may also additionally comprise one or more components such as surface-active compounds, lubricants, wetting agents, dispersants, hydrophobic agents, binders, and the like, for the purpose of viscosity adjustment, film-forming properties, and adhesion enhancement, for example.

The printing ink can be deposited into a functional film by various printing or coating techniques. Suitable printing or coating techniques include, but are not limited to, ink-jet printing, nozzle printing, typography, screen printing, dip coating, spin coating, blade coating, roll printing, torsion printing, lithography, flexography, rotary printing, spray printing, brush coating, pad printing, or slit type extrusion coating, and the like. The exemplary printing techniques are inkjet printing, spray printing, and gravure printing. For more information on printing technology and its related requirements for inks, such as solvents, concentrations, and viscosity, and the like, see “Print media book: Technology and production methods” (Handbook of Print Media: Technologies and Production Methods.) ISBN 3-540-67326-1 edited by Helmut Kipphan. In general, different printing technologies have different requirements for characteristics of the inks used. For example, for a printing ink suitable for ink jet printing, it is necessary to regulate the surface tension, viscosity, and wettability of the ink so that the ink can be ejected through the nozzle at a printing temperature (e.g., room temperature, 25° C.) without any problem, avoiding drying on the nozzle or clogging the nozzle, or facilitating formation of a continuous, flat and defect-free film on a specific substrate.

The printing formulation according to the disclosure comprises at least one functional material.

In the present disclosure, the functional material, in an embodiment, refers to a material having some photoelectric functions. The photoelectric functions include, but are not limited to, hole injection function, hole transport function, electron transport function, electron injection function, electron blocking function, hole blocking function, light emitting function, host function, and light absorption function. The corresponding functional materials are called hole injection material (HIM), hole transport material (HTM), electron transport material (ETM), electron injection material (EIM), electron blocking material (EBM), hole blocking material (HBM), Emitter, Host and organic dyes.

The functional materials can be organic or inorganic materials.

In an exemplary embodiment, the at least one functional material comprised in the printing formulation according to the disclosure is an inorganic nanomaterial.

In some embodiment, in the formulation, the at least one inorganic nanomaterial is an inorganic semiconductor nanoparticle material.

In the present disclosure, the inorganic nanomaterial has an average particle size in the range of about 1 to 1000 nm. In some exemplary embodiments, the inorganic nanomaterial has an average particle size of about 1 to 100 nm. In some other exemplary embodiments, the inorganic nanomaterials have an average particle size of about 1 to 20 nm, in an embodiment, 1 to 10 nm.

The inorganic nanomaterials may be selected from different shapes, including but not limited to different nanotopographies such as spheres, cubes, rods, discs, or branched structures, and a mixture of particles of various shapes.

In an exemplary embodiment, the inorganic nanomaterial is a quantum dot material having a very narrow, monodisperse size distribution, i.e., the size difference among the particles is very small. In an embodiment, the monodispersed quantum dots have a root-mean-square (RMS) deviation less than 15% rms in size; in an embodiment, the monodispersed quantum dots have a RMS deviation in size less than 10% rms; such as, monodisperse the RMS deviation of the monodispersed quantum dots is less than 5% rms.

In an exemplary embodiment, the inorganic nanomaterial is a light-emitting material.

In another exemplary embodiment, the light-emitting inorganic nanomaterial is a quantum dot light-emitting material.

In general, light emitting quantum dots can emit light at a wavelength of 380 nanometers to 2500 nanometers. For example, it has been found that the quantum dots with a CdS core have an emission wavelength in the range of about 400 nm to 560 nm; the quantum dots with a CdSe core have an emission wavelength in the range of about 490 nm to 620 nm; the quantum dots with CdTe cores have an emission wavelength in the range of about 620 nanometers to 680 nanometers; the quantum dots with a InGaP core have an emission wavelength in the range of about 600 nanometers to 700 nanometers; the quantum dots with a PbS core have an emission wavelength in the range of about 800 nanometers to 2500 nanometers; the quantum dots with a PbSe core have an emission wavelength in the range of about 1200 nm to 2500 nm; the quantum dots with a CuInGaS core have an emission wavelength in the range of about 600 nm to 680 nm; the quantum dots with a ZnCuInGaS core have an emission wavelength in the range of about 500 nm to 620 nm; and the quantum dot with a CuInGaSe core have an emission wavelength in the range of about 700 nm to 1000 nm.

In an exemplary embodiment, the quantum dot material includes at least one emitting blue light with a peak luminous wavelength of 450 nm to 460 nm, or green light with a peak luminous wavelength of 520 nm to 540 nm, or red light with a peak luminous wavelength of 615 nm to 630 nm, or their mixture.

Quantum dots included may be selected for particular chemical compositions, topographical structures, and/or size dimensions to obtain light that emits a desired wavelength under electrical stimulation. The relationship between the luminescent properties of quantum dots and their chemical composition, morphology structure and/or size can be found in Annual Review of Material Sci., 2000, 30, 545-610; Optical Materials Express., 2012, 2, 594-628; and Nano Res, 2009, 2, 425-447. The entire contents of the above listed patent documents are hereby incorporated by reference.

The narrow particle size distribution of quantum dots enables them to have a narrower luminescence spectrum (J. Am. Chem. Soc., 1993, 115, 8706; and US 20150108405). In addition, depending on the various chemical composition and structure used, the size of the quantum dots needs to be adjusted within the above-mentioned size range to obtain the luminescent properties of the desired wavelength.

In an embodiment, the light emitting quantum dots are semiconductor nanocrystals. In general, the size of the semiconductor nanocrystals is in the range of about 2 nanometers to about 15 nanometers. In addition, depending on the various chemical composition and structure used, the size of the quantum dots needs to be adjusted within the above-mentioned size range to obtain the luminescent properties of the desired wavelength.

The semiconductor nanocrystal includes at least one semiconductor material, wherein the semiconductor material may be selected from binary or polybasic semiconductor compounds of Group IV, II-VI, II-V, III-V, IV-VI, II-IV-VI, and II-IV-V of the periodic table, or their mixtures. Examples of specific semiconductor materials include, but are not limited to: Group IV semiconductor compounds, including elemental Si, Ge and binary compounds SiC, SiGe; Group II-VI semiconductor compounds, including: binary compounds including CdSe, CdTe, CdO, CdS, CdSe, ZnS, ZnSe, ZnTe, ZnO, HgO, HgS, HgSe, and HgTe, ternary compounds including CdSeS, CdSeTe, CdSTe, CdZnS, CdZnSe, CdZnTe, CgHgS, CdHgSe, ZnSeS, ZnSeTe, ZnSTe, HgSeS, HgSeTe, HgSTe, HgZnS, and HgSeSe, and quaternary compounds including CgHgSeS, CdHgSeTe, CgHgSTe, CdZnSeS, CdZnSeTe, HgZnSeTe, HgZnSTe, CdZnSTe, and HgZnSeS; Group III-V semiconductor compounds, including: binary compounds including AN, AlP, AlAs, AlSb, GaN, GaP, GaAs, GaSb, InN, InP, InAs, and InSb, ternary compounds including AlNP, AlNAs, AlNSb, AlPAs, AlPSb, GaNP, GaNAs, GaNSb, GaPAs, GaPSb, InNP, InNAs, InNSb, InPAs, and InPSb, and quaternary compounds include GaAlNAs, GaAlNSb, GaAlPAs, GaInNP, GaInNAs, GaInNSb, GaInPAs, GaInPSb, InAlNP, InAlNAs, InAlNSb, InAlPAs, and InAlPSb ; Group IV-VI f semiconductor compounds, including: binary compounds including SnS, SnSe, SnTe, PbSe, PbS, and PbTe, ternary compounds including SnSeS, SnSeTe, SnSTe, SnPbS, SnPbSe, SnPbTe, PbSTe, PbSeS, and PbSeTe, and quaternary compounds including SnPbSSe, SnPbSeTe, and SnPbSTe.

In an exemplary embodiment, the light emitting quantum dot comprises a Group II-VI semiconductor material, in an embodiment selected from the group consisting of CdSe, CdS, CdTe, ZnO, ZnSe, ZnS, ZnTe, HgS, HgSe, HgTe, CdZnSe, and any combination thereof. In a suitable embodiment, this material is used as light-emitting quantum dots for visible light due to the relatively well-established synthesis scheme of CdSe and CdS.

In another exemplary embodiment, the light emitting quantum dots comprise a Group III-V semiconductor material, in an embodiment selected from the group consisting of InAs, InP, InN, GaN, InSb, InAsP, InGaAs, GaAs, GaP, GaSb, AlP, AlN, AlAs, AlSb, CdSeTe, ZnCdSe, and any combination thereof

In another exemplary embodiment, the light emitting quantum dots comprise Group IV-VI semiconductor materials, in an embodiment selected from the group consisting of PbSe, PbTe, PbS, PbSnTe, Tl2SnTe5, and any combination thereof

In an exemplary embodiment, the quantum dots have a core-shell structure. The core and the shell respectively include one or more identical or different semiconductor materials.

The core of the quantum dots may be selected from binary or polybasic semiconductor compounds of Group IV, II-VI, II-V, III-V, IV-VI, I-III-VI, II-IV-VI, and II-IV-V of the periodic table. Specific examples used as quantum dot cores include but are not limited to ZnO, ZnS, ZnSe, ZnTe, CdO, CdS, CdSe, CdTe, MgS, MgSe, GaAs, GaN, GaP, GaSe, GaSb, HgO, HgS, HgSe, HgTe, InAs, InN, InSb, AlAs, AlN, AlP, AlSb, PbO, PbS, PbSe, PbTe, Ge, Si, and an alloy or a mixture of any combination thereof.

The shell of the quantum dots comprises the same or different semiconductor material as the core. Semiconductor materials that can be used for the shell include binary or polybasic semiconductor compounds of Group Group IV, II-VI, II-V, III-V, IV-VI, I-III-IV, II-IV-VI, and II-IV-V of the periodic table. Specific examples for quantum dot cores include, but are not limited to, ZnO, ZnS, ZnSe, ZnTe, CdO, CdS, CdSe, CdTe, MgS, MgSe, GaAs, GaN, GaP, GaSe, GaSb, HgO, HgS, HgSe, HgTe, InAs, InN, InSb, AlAs, AIN, AlP, AlSb, PbO, PbS, PbSe, PbTe, Ge, Si, and an alloy or a mixture of any combination thereof.

In the quantum dots having a core-shell structure, the shell may comprisea monolayer or multilayer structure. The shell comprises one or more semiconductor materials that are the same as or different from the core. In an exemplary embodiment, the shell has a thickness of about 1 to 20 layers. In another exemplary embodiment, the shell has a thickness of about 5 to 10 layers. In certain embodiments, two or more shells are comprisedon the surface of the quantum dot core.

In an exemplary embodiment, the semiconductor material used for the shell has a larger bandgap than the core. Particularly suitably, the core has a type I semiconductor heterojunction structure.

In another exemplary embodiment, the semiconductor material used for the shell has a smaller bandgap than the core.

In an exemplary embodiment, the semiconductor material used for the shell has the same or similar atomic crystal structure as the core. This choice is conducive to reducing the stress between the core and shell, making the quantum dots more stable.

Examples of suitable light-emitting quantum dots employing core-shell structures are (but not limited to):

Red light: CdSe/CdS, CdSe/CdS/ZnS, CdSe/CdZnS, and the like;

Green light: CdZnSe/CdZnS, CdSe/ZnS, and the like;

Blue light: CdS/CdZnS, CdZnS/ZnS, and the like.

The exemplary method for preparing the quantum dots is a colloidal growth method. In an exemplary embodiment, the method of preparing the monodispersed quantum dots is selected from the group consisting of hot-injection and/or heating-up. Preparation methods are described in the document Nano Res, 2009, 2, 425-447; Chem. Mater., 2015, 27 (7), pp 2246-2285. The contents of the above listed documents are hereby incorporated by reference in their entirety.

In an exemplary embodiment, the surface of the quantum dot contains an organic ligand. The organic ligand can control the growth process, regulate the morphology, and reduce the surface defects of the quantum dots, so as to improve the luminous efficiency and stability of the quantum dots. The organic ligand may be selected from the group consisting of pyridine, pyrimidine, furan, amine, alkyl phosphine, alkyl phosphine oxide, alkyl phosphonic acid or alkyl phosphinic acid, alkyl thiol, and the like. Examples of specific organic ligands include but are not limited to tri-n-octylphosphine, tri-n-octylphosphine oxide, trihydroxypropylphosphine, tributylphosphine, tri(dodecyl)phosphine, dibutyl phosphite, tributyl phosphite, octadecyl phosphite, trilauryl phosphite, tridodecyl phosphite, triisodecyl phosphite, bis(2-ethylhexyl) phosphate, tri(tridecyl)phosphate, hexadecylamine, oleylamine, octadecylamine, dioctadecylamine, trioctadecylamine, bis(2-ethylhexyl)amine, octylamine, dioctylamine, trioctylamine, dodecylamine, didodecylamine, tridodecylamine, hexadecylamine, phenylphosphoric acid, hexylphosphonic acid, tetradecylphosphonic acid, octylphosphonic acid, n-octadecylphosphonic acid, propylene diphosphonic acid, dioctyl ether, diphenyl ether, octanethiol, and dodecanethiol.

In another exemplary embodiment, the surface of the quantum dot comprises an inorganic ligand. Quantum dots protected by inorganic ligands can be obtained by ligand exchange of organic ligands on the surface of quantum dots. Examples of specific inorganic ligands include but are not limited to: S²⁻, HS⁻, Se²⁻, HSe⁻, Te²⁻, HTe⁻, TeS₃²⁻, OH⁻, NH₂⁻, PO₄³⁻, MoO₄²⁻, and the like. Examples of such inorganic ligand quantum dots can be found in documents: J. Am. Chem. Soc. 2011, 133, 10612-10620; and ACS Nano, 2014, 9, 9388-9402. The contents of the above listed documents are hereby incorporated by reference in their entirety.

In certain embodiments, the quantum dot has one or more of the same or different ligands on the surface.

In an exemplary embodiment, the luminescence spectrum exhibited by the monodispersed quantum dots has a symmetrical peak shape and a narrow half-width. In general, the better the monodispersity of a quantum dot, the more symmetrical the luminescence peak it exhibits and the narrower the half-value width. In one embodiment, the luminescence half-width of the quantum dots is less than 70 nanometers; in another embodiment, the luminescence half-width of the quantum dots is less than 40 nanometers; and in yet another embodiment, the luminescence half-width of the quantum dot is less than 30 nm.

In general, the quantum efficiency of the quantum dots is greater than 10%, in one embodiment, the quantum efficiency of the quantum dots is greater than 50%; in another embodiment, the quantum efficiency of the quantum dots is greater than 60%; and in yet another embodiment, the quantum efficiency of the quantum dots is greater than 70%.

Other information quantum dot-related materials, techniques, methods, applications, and the like that may be useful in the present disclosure are described in the following patent documents: WO2007/117698, WO2007/120877, WO2008/108798, WO2008/105792, WO2008/111947, WO2007/092606, WO2007/117672, WO2008/033388, WO2008/085210, WO2008/13366, WO2008/063652, WO2008/063653, WO2007/143197, WO2008/070028, WO2008/063653, U.S. Pat. No. 6,207,229, U.S. Pat. No. 6,251,303, U.S. Pat. No. 6,319,426, U.S. Pat. No. 6,426,513, U.S. Pat. No. 6,576,291, U.S. Pat. No. 6,607,829, U.S. Pat. No. 6,861,155, U.S. Pat. No. 6,921,496, U.S. Pat. No. 7,060,243, U.S. Pat. No. 7,125,605, U.S. Pat. No. 7,138,098, U.S. Pat. No. 7,150,910, U.S. Pat. No. 7,470,379, U.S. Pat. No. 7,566,476, and WO2006134599A1, which are hereby incorporated by reference in their entireties.

In another exemplary embodiment, the light emitting semiconductor nanocrystals are nanorods. Nanorods have different properties from spherical nanocrystallites. For example, the luminescence of the nanorods is polarized along the long rod axis, while the luminescence of the spherical grains is non-polarized (see Woggon et al., Nano Lett., 2003, 3, p509). Nanorods have excellent optical gain properties, making them potentially useful as laser gain materials (see Banin et al. Adv. Mater. 2002, 14, p317). In addition, the luminescence of the nanorods can be turned on and off reversibly under the control of an external electric field (see Banin et al., Nano Lett. 2005, 5, p1581). These properties of nanorods can be, in an embodiment, incorporated into the device of the present disclosure under certain conditions. Examples of the preparation of semiconductor nanorods are WO03097904A1, US2008188063A1, US2009053522A1, and KR20050121443A, the entire contents of which are hereby incorporated by reference.

In other exemplary embodiments, in the formulation according to the disclosure, the inorganic nanomaterial is a perovskite nanoparticle material, in particular a light emitting perovskite nanoparticle material.

The perovskite nanoparticle material has a structural formula of AMX₃ wherein A can be selected from organic amines or alkali metal cations, M can be selected from metal cations, and X can be selected from oxygen or a halide anion. Specific examples include but are not limited to: CsPbCl₃, CsPb(Cl/Br)₃, CsPbBr₃, CsPb(I/Br)₃, CsPbI₃, CH₃NH₃PbCl₃, CH₃NH₃Pb(Cl/Br)₃, CH₃NH₃PbBr₃, CH₃NH₃Pb(I/Br)₃, CH₃NH₃PbI₃, and so on. The literature on perovskite nanoparticle materials is for example NanoLett., 2015, 15, 3692-3696; ACS Nano , 2015, 9, 4533-4542; Angewandte Chemie, 2015, 127(19): 5785-5788; Nano Lett., 2015, 15 (4), pp 2640-2644; Adv. Optical Mater.2014, 2, 670-678; The Journal of Physical Chemistry Letters, 2015, 6(3): 446-450; J. Mater. Chem. A, 2015,3, 9187-9193; Inorg. Chem. 2015, 54, 740 - 745; RSC Adv., 2014,4, 55908-55911; J. Am. Chem. Soc., 2014, 136 (3), pp 850-853; Part. Part. Syst. Charact. 2015, doi: 10.1002/ppsc.201400214; and Nanoscale, 2013, 5(19): 8752-8780. The entire contents of the above listed patent documents are hereby incorporated by reference.

In another exemplary embodiment, the inorganic nanomaterial is a metal nanoparticle material in the printing formulation according to the present disclosure.Particularly suitable are light-emitting metal nanoparticle materials.

The metal nanoparticles include, but are not limited to nanoparticles of chromium (Cr), molybdenum (Mo), tungsten (W), ruthenium (Ru), rhenium (Rh), nickel (Ni), silver (Ag), copper (Cu), Zinc (Zn), Palladium (Pd), Gold (Au), Hungry (Os), Re, Iridium (Ir) and Platinum (Pt). The types, morphology and synthesis methods of common metal nanoparticles can be found in: Angew. Chem. Int. Ed. 2009, 48, 60-103; Angew. Chem. Int. Ed. 2012, 51, 7656-7673; Adv. Mater. 2003, 15, No. 5, 353-389; Adv. Mater. 2010, 22, 1781-1804; Small.2008, 3, 310-325; and Angew. Chem. Int. Ed. 2008, 47, 2- 46, et al., and references cited therein, which are hereby incorporated by reference in their entireties.

In another exemplary embodiment, the inorganic nanomaterial has charge transport capability.

In an exemplary embodiment, the inorganic nanomaterial has electron transport capability. In an embodiment, such inorganic nanomaterials are selected from n-type semiconductor materials. Examples of n-type inorganic semiconductor materials include, but are not limited to, metal chalcogenides, metal-phosphorus compounds, or elemental semiconductors such as metal oxides, metal sulfides, metal selenides, metal tellurides, metal nitrides, metal phosphide, or metal arsenide. The exemplary n-type inorganic semiconductor material is selected from the group consisting of ZnO, ZnS, ZnSe, TiO2, ZnTe, GaN, GaP, AlN, CdSe, CdS, CdTe, CdZnSe, and any combination thereof.

In some embodiments, the inorganic nanomaterial has hole transport capability. In an embodiment, such inorganic nanomaterials are selected from p-type semiconductor materials. The inorganic p-type semiconductor material may be NiOx, WOx, MoOx, RuOx, VOx, CuOx, and any combination thereof.

In some embodiments, a printing ink according to the present disclosure comprises at least two or moreinorganic nanomaterials.

In another particularly suitable embodiment, the formulation according to the disclosure comprises at least one organic functional material.

The organic functional materials include, but are not limited to, hole (also called electron hole) injection or transport material (HIM/HTM), hole blocking material (HBM), electron injection or transport material (EIM/ETM), electron blocking material (EBM), organic host material (Host), singlet emitter (fluorescent emitter), thermally activated delayed fluorescent emitter (TADF), triplet emitter (phosphorescent emitter), in particular, organic emitting metal complexes, and organic dyes. Various organic functional materials are described in detail in, for example, WO2010135519A1, US20090134784A1, and WO2011110277A1, the entire contents of which are hereby incorporated by reference.

In general, the solubility of the organic functional material in the organic solvent according to the present disclosure is at least 0.2 wt %. In one embodiment, the solubility of the organic functional material in the organic solvent according to the present disclosure is at least 0.3 wt %; in another embodiment, the solubility of the organic functional material in the organic solvent according to the present disclosure is at least 0.6 wt %; still in yet another embodiment, the solubility of the organic functional material in the organic solvent according to the present disclosure is at least 1.0 wt %. In some embodiment, the solubility of the organic functional material in the organic solvent according to the present disclosure is at least 1.5 wt %.

Organic functional materials can be small molecules and polymer materials. In the present disclosure, a small-molecule organic material refers to a material having a molecular weight of at most 4000 g/mol, and a material having a molecular weight of more than 4000 g/mol is collectively referred to as a polymer.

More detailed descriptions of the organic small-molecule functional materials will be given below for exemplary embodiments, but not limited thereto.

In an exemplary embodiment, the functional material comprised in the printing formulation according to the disclosure is an organic small-molecule material.

In some exemplary embodiments, in the printing formulation according to the disclosure, the organic functional material comprises at least one host material and at least one emitter.

In an exemplary embodiment, the organic functional material comprises a host material and a singlet emitter.

In another exemplary embodiment, the organic functional material comprises a host material and a triplet emitter.

In another exemplary embodiment, the organic functional material comprises a host material and a thermally activated delayed fluorescent light emitting material.

In other exemplary embodiments, the organic functional material comprises a hole transport material (HTM). In an embodiment, the HTM comprises a crosslinkable group.

More detailed descriptions of the organic small-molecule functional materials will be given below for exemplary embodiments, but not limited thereto.

1. HIM/HTM/EBM

Suitable organic HIM/HTM materials for use may include compounds having the following structural units: phthalocyanines, porphyrins, amines, aryl amines, biphenyl triaryl amines, thiophenes, thiophenes such as dithiophenethiophene and thiophthene, pyrrole, aniline, carbazole, indeno-fluorene, and derivatives thereof. Other suitable HIMs also include: fluorocarbon-containing polymers; polymers comprising conductive dopants; and conductive polymers such as PEDOT/PSS.

The electron-blocking layer (EBL) used is typically used to block electrons from adjacent functional layers, particularly light emitting layers. In contrast to a light-emitting device without a blocking layer, the presence of EBL usually results in an increase in luminous efficiency. The electron-blocking material (EBM) of the electron-blocking layer (EBL) requires a higher LUMO than the adjacent functional layer, such as the light emitting layer. In an exemplary embodiment, the EBM has a greater level of excited energy than the adjacent light-emitting layer, such as a singlet or triplet level, depending on the emitter. In another exemplary embodiment, the EBM has a hole-transport function. HIM/HTM materials, which typically have high LUMO levels, can be used as EBM.

Examples of cyclic aromatic amine-derived compounds that can be used as HIM, HTM or FBM may include hut are not limited to the general structure as follows:

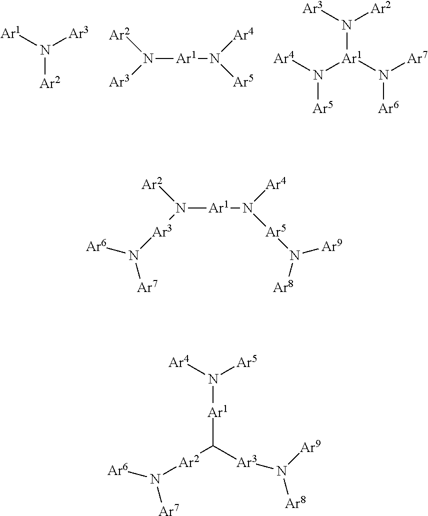

wherein each Ar¹ to Arg may be independently selected from: cyclic aryl groups such as benzene, biphenyl, triphenyl, benzo, naphthalene, anthracene, phenalene, phenanthrene, fluorene, pyrene, chrysene, perylene, azulene; and aromatic heterocyclic groups such as dibenzothiophene, dibenzofuran, furan, thiophene, benzofuran, benzothiophene, benzoselenophene, carbazole, pyrazole, imidazole, triazole, isoxazole, thiazole, oxadiazole, oxatriazole, dioxazole, thiadiazole, pyridine, pyridazine, pyrimidine, pyrazine, triazine, oxazine, oxathiazin, oxadiazine, indole, benzimidazole, indoxazine, bisbenzoxazole, benzisoxazole, benzothiazole, quinoline, isoquinoline, cinnoline, quinazoline, quinoxaline, naphthalene, phthalein, pteridine, xanthene, acridine, phenazine, phenothiazine, phenoxazine, dibenzoselenophene, benzoselenophene, benzofuropyridine, indolocarbazole, pyridylindole, pyrrolodipyridine, furodipyridine, benzothienopyridine, thienodipyridine, benzoselenophenopyridine, and selenophenodipyridine; groups comprising 2 to 10 ring structures which may be the same or different types of cyclic aryl or aromatic heterocyclic group and are bonded to each other directly or through at least one of the following groups, for example: oxygen atom, nitrogen atom, sulfur atom, silicon atom, phosphorus atom, boron atom, chain structure unit, and aliphatic cyclic group; and wherein each Ar may be further optionally substituted, and the substituents may optionally be hydrogen, alkyl, alkoxy, amino, alkene, alkyne, aralkyl, heteroalkyl, aryl and heteroaryl.

In one aspect, Ar¹ to Ar⁹may be independently selected from the group consisting of:

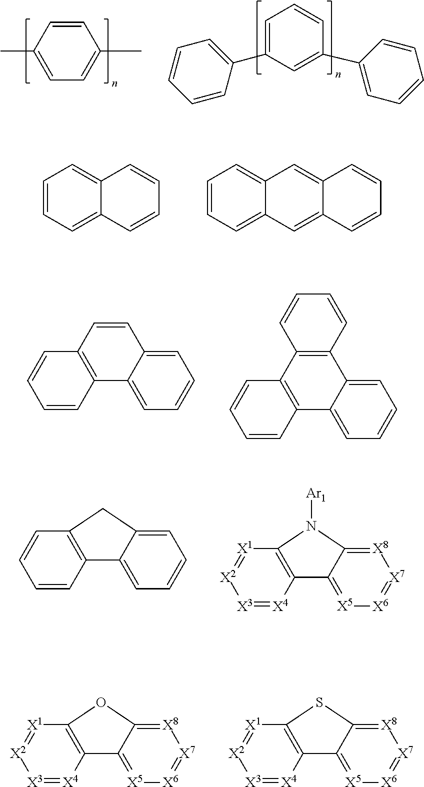

wherein n is an integer of 1 to 20; X¹ to X⁸ are CH or N; Ar¹ is as defined above.

Additional non-limiting examples of cyclic aryl amine-derived compounds may be found in U.S. Pat. No. 3,567,450, U.S. Pat. No. 4,720,432, U.S. Pat. No. 5,061,569, U.S. Pat. No. 3,615,404, and U.S. Pat. No. 5,061,569.

Examples of metal complexes that may be used as HTM or HIM include, but are not limited to, the general structure as follows:

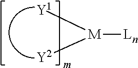

wherein M may be a metal having an atomic weight greater than 40; and

(Y¹-Y²) is a bidentate ligand, wherein Y¹ and Y² are independently selected from C, N, O, P, and S; L is an auxiliary ligand; m is an integer from 1 to the maximum coordination number of the metal; m+n is the maximum coordination number of the metal.

In one embodiment, (Y¹-Y²) may be a 2-phenylpyridine derivative.

In another embodiment, (Y¹-Y²) may be a carbene ligand.

In another embodiment, M may be selected from Ir, Pt, Os, and Zn.

In another aspect, the HOMO of the metal complex is greater than −5.5 eV (relative to the vacuum level).

Suitable examples of HIM/HTM compounds are set forth in the following table:

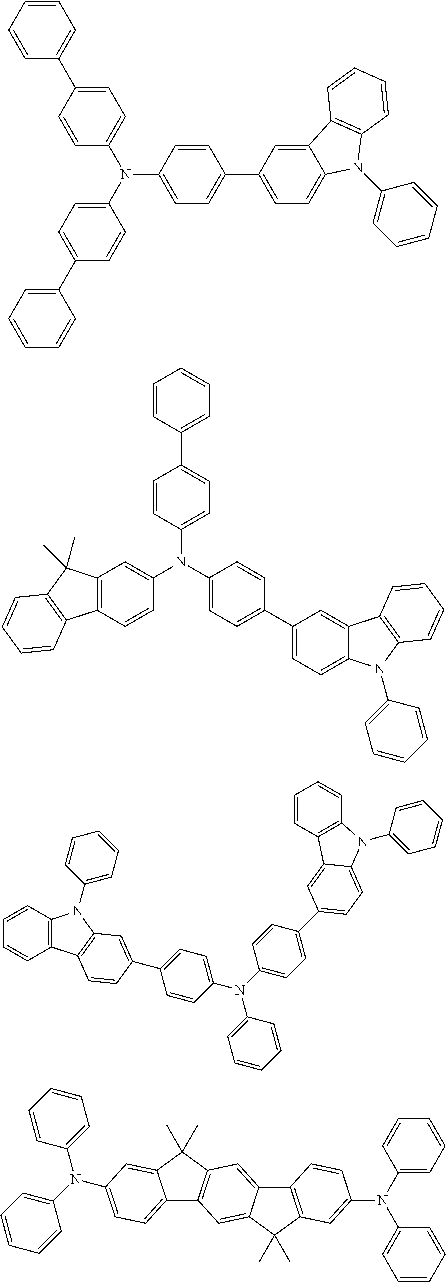

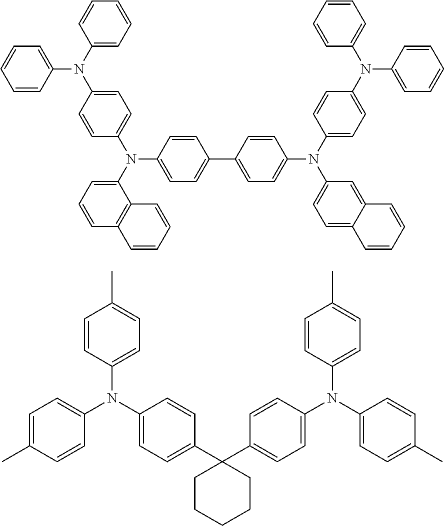

2. Triplet Host

Examples of a triplet host material used are not particularly limited and any metal complex or organic compound may be used as the host material as long as its triplet energy is greater than that of the light emitter, especially a triplet emitter or phosphorescent emitter.

Examples of metal complexes that may be used as triplet hosts may include, but are not limited to, the general structure as follows:

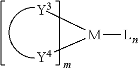

wherein M may be a metal; (Y³-Y⁴) may be a bidentate ligand, Y³ and Y⁴ may be independently selected from C, N, O, P, and S; L may be an auxiliary ligand; m may be an integer with the value from 1 to the maximum coordination number of the metal; and, m+n is the maximum number of coordination of the metal.

In an exemplary embodiment, the metal complex which may be used as the triplet host has the following form:

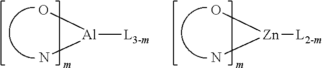

(O—N) may be a bidentate ligand in which the metal is coordinated to O and N atoms.

In one embodiment, M may be selected from Ir and Pt.

Examples of organic compounds that may be used as triplet host are selected from: compounds comprising cyclic aryl groups, such as benzene, biphenyl, triphenyl, benzo, and fluorene; compounds comprising aromatic heterocyclic groups, such as triphenylamine, dibenzothiophene, dibenzofuran, dibenzoselenophen, furan, thiophene, benzofuran, benzothiophene, benzoselenophene, carbazole, indolocarbazole, indolopyridine, pyrrolodipyridine, pyrazole, imidazole, triazole, oxazole, thiazole, oxadiazole, oxatriazole, dioxazole, thiadiazole, pyridine, pyridazine, pyrimidine, pyrazine, triazine, oxazine, oxathiazin, oxadiazine, indole, benzimidazole, indoxazine, bisbenzoxazole, isoxazole, benzothiazole, quinoline, isoquinoline, cinnoline, quinazoline, quinoxaline, naphthalene, phthalein, pteridine, xanthene, acridine, phenazine, phenothiazine, phenoxazine, benzofuropyridine, furodipyridine, benzothienopyridine, thienodipyridine, benzoselenophenopyridine, and selenophenodipyridine, or a combination thereof and groups comprising 2 to 10 ring structures, which may be the same or different types of cyclic aryl or aromatic heterocyclic group and are linked to each other directly or by at least one of the following groups, such as oxygen atom, nitrogen atom, sulfur atom, silicon atom, phosphorus atom, boron atom, chain structure unit, and aliphatic ring, wherein each Ar may be further optionally substituted and the substituents may be any one of hydrogen, alkyl, alkoxy, amino, alkene, alkyne, aralkyl, heteroalkyl, aryl and heteroaryl, or a combination thereof

In an exemplary embodiment, the triplet host material may be selected from compounds comprising at least one of the following groups:

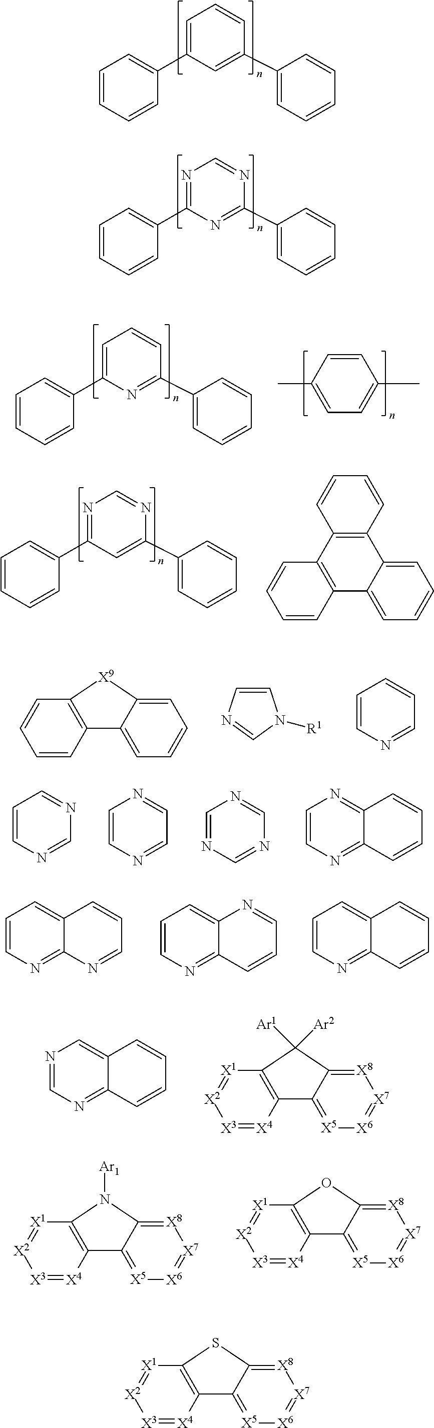

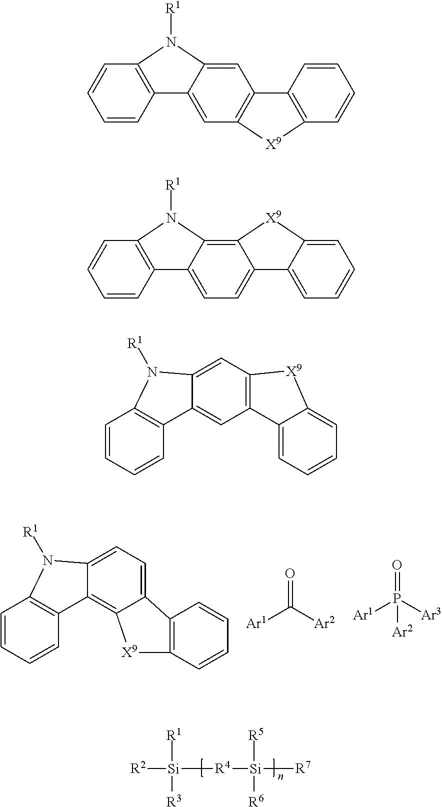

wherein R¹-R⁷ each may be independently selected from the following groups: hydrogen, alkyl, alkoxy, amino, alkene, alkyne, aralkyl, heteroalkyl, aryl and heteroaryl; wherein, when they are aryl or heteroaryl, they have the same meaning as Ar¹ and Ar² above; n is an integer from 0 to 20; X¹-X⁸ are selected from CH or N; and X⁹ is selected from CR¹R² or NR¹.

Examples of suitable triplet host material are listed in the following table:

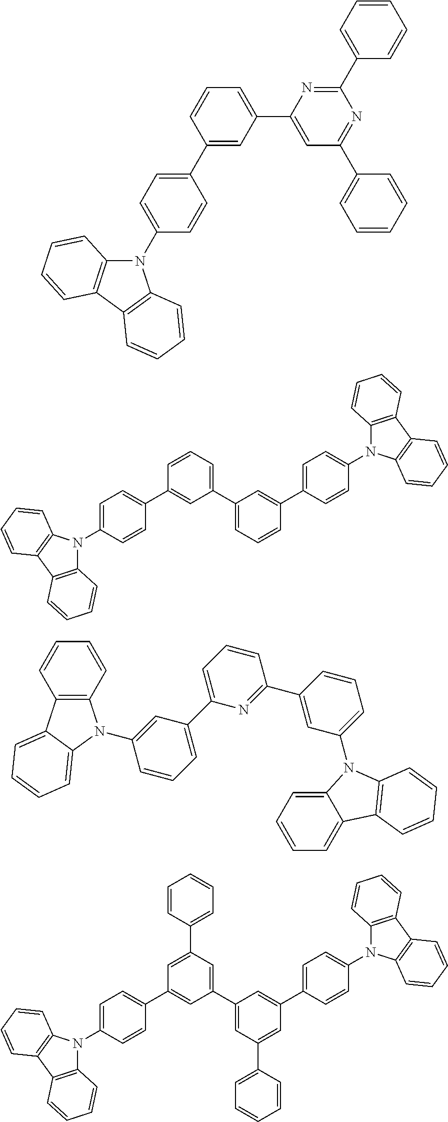

3. Singlet Host

Examples of singlet host material used i are not particularly limited and any organic compound may be used as the host as long as its singlet state energy is greater than that of the light emitter, especially the singlet emitter or fluorescent light emitter.

Non-limiting examples of organic compounds used as singlet host materials may be selected from: cyclic aryl compounds, such as benzene, biphenyl, triphenyl, benzo, naphthalene, anthracene, phenalene, phenanthrene, fluorene, pyrene, chrysene, perylene, azulene; aromatic heterocyclic compounds, such as triphenylamine, dibenzothiophene, dibenzofuran, dibenzoselenophen, furan, thiophene, benzofuran, benzothiophene, benzoselenophene, carbazole, indolocarbazole, indolopyridine, pyrrolodipyridine, pyrazole, imidazole, triazole, isoxazole, thiazole, oxadiazole, oxatriazole, dioxazole, thiadiazole, pyridine, pyridazine, pyrimidine, pyrazine, triazine, oxazine, oxathiazin, oxadiazine, indole, benzimidazole, indoxazine, bisbenzoxazole, isoxazole, benzothiazole, quinoline, isoquinoline, cinnoline, quinazoline, quinoxaline, naphthalene, phthalein, pteridine, xanthene, acridine, phenazine, phenothiazine, phenoxazine, benzofuropyridine, furodipyridine, benzothienopyridine, thienodipyridine, benzoselenophenopyridine, and selenophenodipyridine; and groups comprising 2 to 10 ring structures, which may be the same or different types of cyclic aryl or aromatic heterocyclic group and are linked to each other directly or by at least one of the following groups, such as oxygen atom, nitrogen atom, sulfur atom, silicon atom, phosphorus atom, boron atom, chain structure unit, and aliphatic rings.

In an exemplary embodiment, the monomorphic host material may be selected from compounds comprising at least one of the following groups:

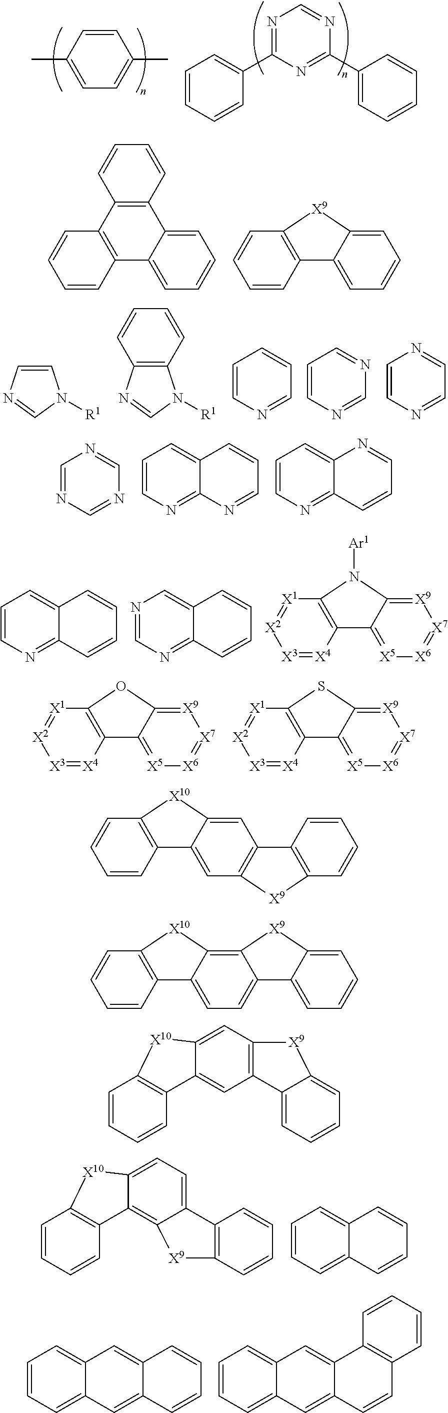

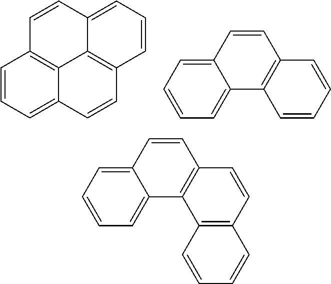

wherein R¹ may be independently selected from the following groups: hydrogen, alkyl, alkoxy, amino, alkene, alkyne, aralkyl, heteroalkyl, aryl and heteroaryl; Ar¹ is an aryl or heteroaryl and has the same meaning as Ar¹ in HTM above; n is an integer from 0 to 20; X¹-X⁸ are selected from CH or N; and X⁹ and X¹⁰ are selected from CR¹R² or NR¹.

Examples of suitable anthryl-based singlet host material are listed in the following table:

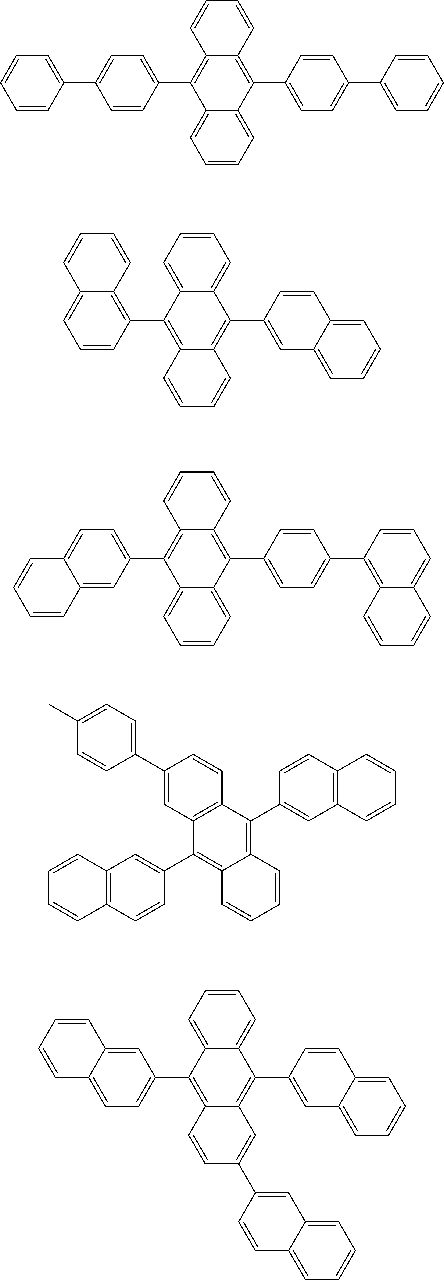

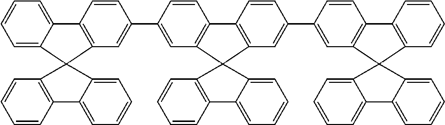 [SMILES: c1ccc2c(c1)CC1(Cc3ccccc3-2)c2ccccc2-c2ccc(-c3ccc4c(c3)C3(Cc5ccccc5-c5ccccc5C3)c3cc(-c5ccc6c(c5)C5(Cc7ccccc7-c7ccccc7C5)c5ccccc5-6)ccc3-4)cc21]

4. Singlet Emitter

The singlet emitter tends to have a longer conjugate π-electron system. To date, there have been many examples, such as, but not limited to, styrylamine and its derivatives disclosed in JP2913116B and WO2001021729A1, and indenofluorene and its derivatives disclosed in WO2008/006449 and WO2007/140847.

In an exemplary embodiment, the singlet emitter may be selected from the group consisting of monostyrylamines, distyrylamines, tristyrylamines, tetrastyrylamines, styrylphosphines, styryl ethers, and arylamines, or combinations thereof.

Mono styrylamine refers to a compound which comprises an unsubstituted or optionally substituted styryl group and at least one amine, such as an aryl amine. Distyrylamine refers to a compound comprising two unsubstituted or optionally substituted styryl groups and at least one amine, such as an aryl amine. Ternarystyrylamine refers to a compound which comprises three unsubstituted or optionally substituted styryl groups and at least one amine, such as an aryl amine. Quaternarystyrylamine refers to a compound comprising four unsubstituted or optionally substituted styryl groups and at least one amine, such as an aryl amine. Exemplary styrene is stilbene, which may be further optionally substituted. The corresponding phosphines and ethers are defined similarly to amines. Aryl amine or aryl amine refers to a compound comprising three unsubstituted or optionally substituted cyclic or heterocyclic aryl systems directly attached to nitrogen. At least one of these cyclic or heterocyclic aryl systems is for example selected from fused ring systems such as has at least 14 aromatic ring atoms. Among the exemplary examples are aryl anthramine, aryl anthradiamine, aryl pyrene amines, aryl pyrene diamines, aryl chrysene amines and aryl chrysene diamine. Aryl anthramine refers to a compound in which a diarylamino group is directly attached to anthracene, such as at position 9. Aryl anthradiamine refers to a compound in which two diarylamino groups are directly attached to anthracene, such as at positions 9, 10. Aryl pyrene amines, aryl pyrene diamines, aryl chrysene amines and aryl chrysene diamine are similarly defined, wherein the diarylarylamino group is such as attached to position 1 or 1 and 6 of pyrene.

Examples of singlet emitter based on vinylamine and arylamine are also exemplary examples which may be found in the following patent documents: WO 2006/000388, WO 2006/058737, WO 2006/000389, WO 2007/065549, WO 2007/115610, U.S. Pat. No. 7,250,532 B2, DE 102005058557 A1, CN 1583691 A, JP 08053397 A, U.S. Pat. No. 6,251,531 B1, US 2006/210830 A, EP 1957606 A1, and US 2008/0113101 A1. The entire contents of the above listed patent documents are hereby incorporated by reference.

Examples of singlet light emitters based on distyrylbenzene and its derivatives may be found in, for example, U.S. Pat. No. 5,121,029.

Further exemplary singlet emitters may be selected from the group consisting of: indenofluorene-amine and indenofluorene-diamine as disclosed in WO 2006/122630, benzoindenofluorene-amine and benzoindenofluorene-diamine as disclosed in WO 2008/006449, dibenzoindenofluorene-amine and dibenzoindenofluorene-diamine as disclosed in WO2007/140847.

Other materials useful as singlet emitters include polycyclic aryl compounds, especially any one selected from the derivatives of the following compounds: anthracenes such as 9,10-di-naphthylanthracene, naphthalene, tetraphenyl, phenanthrene, perylene such as 2,5,8,11-tetra-t-butylatedylene, indenoperylene, phenylenes such as 4,4′-(bis (9-ethyl-3-carbazovinylene)-1,1′-biphenyl, periflanthene, decacyclene, coronene, fluorene, spirobifluorene, arylpyren (e.g., US20060222886), arylenevinylene (e.g., U.S. Pat. No. 5,121,029, U.S. Pat. No. 5,130,603), cyclopentadiene such as tetraphenylcyclopentadiene, rubrene, coumarine, rhodamine, quinacridone, pyrane such as 4 (dicyanoethylene)-6-(4-dimethylaminostyryl-2-methyl)-4H-pyrane (DCM), thiapyran, bis (azinyl) imine-boron compounds (US 2007/0092753 A1), bis (azinyl) methene compounds, carbostyryl compounds, oxazone, benzoxazole, benzothiazole, benzimidazole, and diketopyrrolopyrrole, or combinations thereof. Non-limiting examples of some singlet emitter material may be found in the following patent documents: US 20070252517 A1, U.S. Pat. No. 4,769,292, U.S. Pat. No. 6,020,078, US 2007/0252517 A1, and US 2007/0252517 A1. The entire contents of the above listed patent documents are hereby incorporated by reference.

Examples of suitable singlet emitters are listed in the following table:

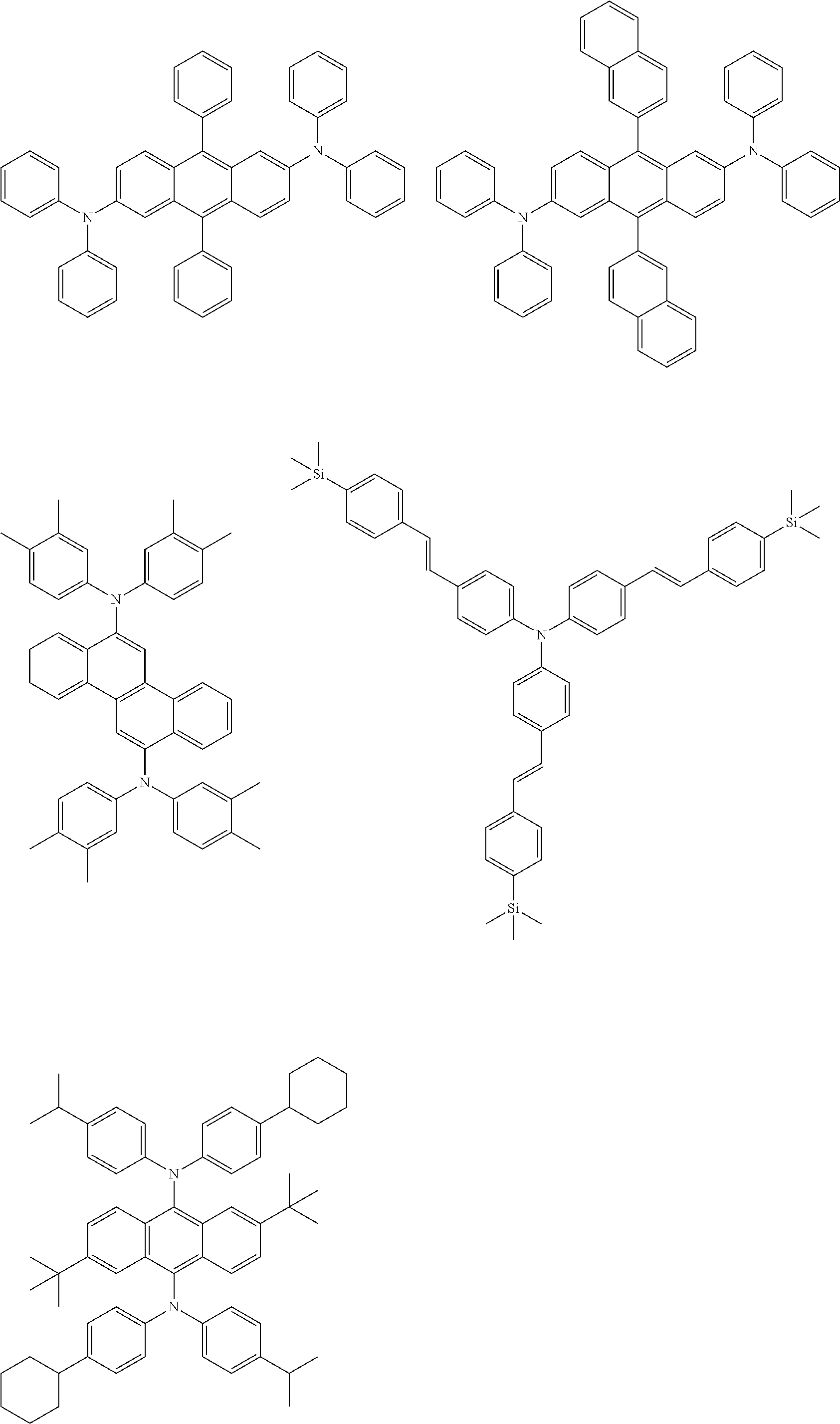

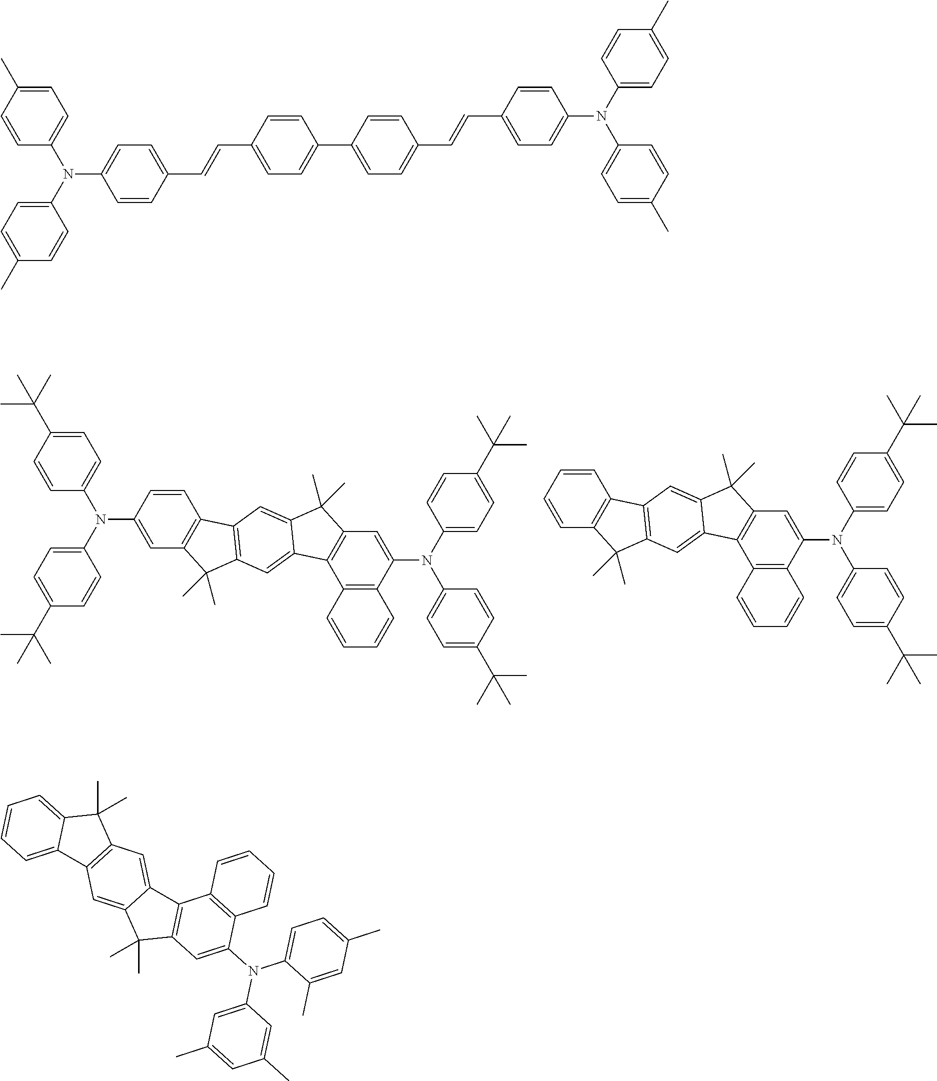

5. Thermally Activated Delayed Fluorescent Material (TADF):

Traditional organic fluorescent materials can only emit light using 25% singlet excitonic luminescenceformed by electrical excitation, and the devices have relatively low internal quantum efficiency (up to 25%). The phosphorescent material enhances the intersystem crossing due to the strong spin-orbit coupling of the heavy atom center, the singlet exciton and the triplet exciton luminescence formed by the electric excitation can be effectively utilized, so that the internal quantum efficiency of the device can reach 100%. However, the phosphor materials are expensive, the material stability is poor, and the device efficiency roll-off is a serious problem, which limit its application in OLED. Thermally-activated delayed fluorescent materials are the third generation of organic light-emitting materials developed after organic fluorescent materials and organic phosphorescent materials. This type of material generally has a small singlet-triplet energy level difference (ΔEst), and triplet excitons can be converted to singlet excitons by intersystem crossing. This can make full use of the singlet excitons and triplet excitons formed under electric excitation. The device can achieve 100% quantum efficiency.

The TADF material needs to have a small singlet-triplet energy level difference, typically ΔEst<0.3 eV, for example ΔEst<0.2 eV, for example ΔEst<0.1 eV, such as ΔEst<0.05 eV. In an exemplary embodiment, TADF has good fluorescence quantum efficiency. Some TADF emitting materials can be found in the following patent documents: CN103483332(A), TW201309696(A), TW201309778(A), TW201343874(A), TW201350558(A), US20120217869(A1), WO2013133359(A1), WO2013154064 (A1), Adachi, et.al. Adv. Mater., 21, 2009, 4802, Adachi, et.al. Appl. Phys. Lett., 98, 2011, 083302, Adachi, et.al. Appl. Phys. Lett ., 101, 2012, 093306, Adachi, et. al. Chem. Commun., 48, 2012, 11392, Adachi, et.al. Nature Photonics, 6, 2012, 253, Adachi, et.al. Nature, 492, 2012, 234, Adachi, et.al. J. Am. Chem. Soc, 134, 2012, 14706, Adachi, et.al. Angew. Chem. Int. Ed, 51, 2012, 11311, Adachi, et.al. Chem. Commun., 48, 2012, 9580, Adachi, et.al. Chem. Commun., 48, 2013, 10385, Adachi, et.al. Adv. Mater., 25, 2013, 3319, Adachi, et.al . Adv. Mater., 25, 2013, 3707, Adachi, et.al. Chem. Mater., 25, 2013, 3038, Adachi, et.al. Chem. Mater., 25, 2013, 3766, Adachi, et. Al. J. Mater. Chem. C., 1, 2013, 4599, Adachi, et.al. J. Phys. Chem. A., 117, 2013, 5607. The entire contents of the above listed patent or literature documents are hereby incorporated by reference.

Some examples of suitable TADF light-emitting materials are listed in the following table:

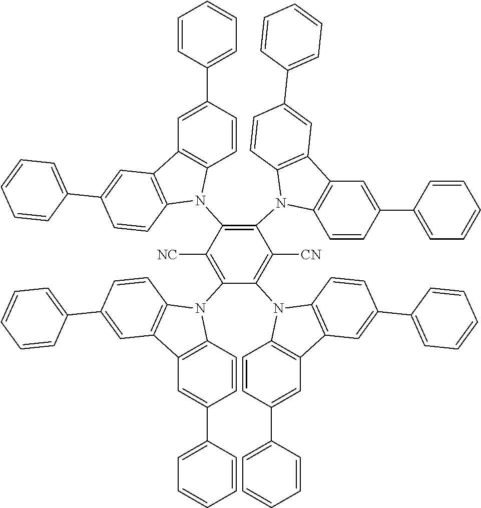 [SMILES: N#Cc1c(-n2c3ccc(-c4ccccc4)cc3c3cc(-c4ccccc4)ccc32)c(-n2c3ccc(-c4ccccc4)cc3c3cc(-c4ccccc4)ccc32)c(C#N)c(-n2c3ccc(-c4ccccc4)cc3c3cc(-c4ccccc4)ccc32)c1-n1c2ccc(-c3ccccc3)cc2c2cc(-c3ccccc3)ccc21]

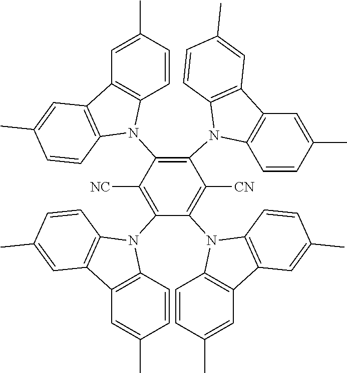

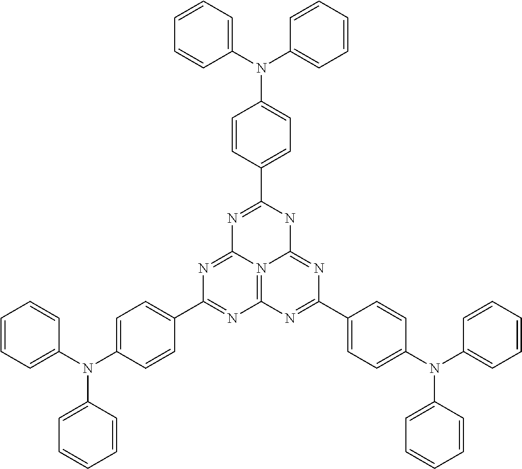

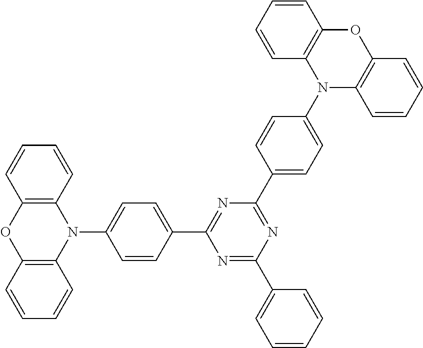 [SMILES: c1ccc(-c2nc(-c3ccc(N4c5ccccc5Oc5ccccc54)cc3)nc(-c3ccc(N4c5ccccc5Oc5ccccc54)cc3)n2)cc1]

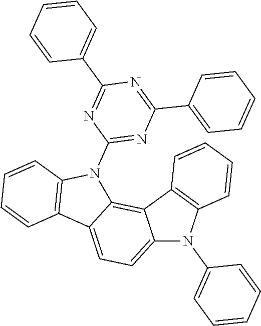 [SMILES: c1ccc(-c2nc(-c3ccccc3)nc(-n3c4ccccc4c4ccc5c(c6ccccc6n5-c5ccccc5)c43)n2)cc1]

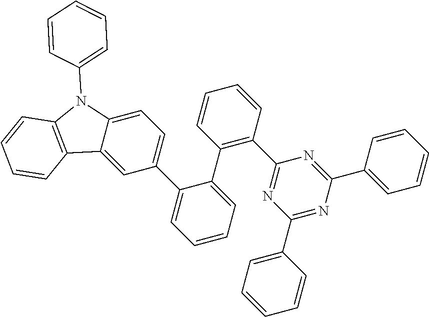 [SMILES: c1ccc(-c2nc(-c3ccccc3)nc(-c3ccccc3-c3ccccc3-c3ccc4c(c3)c3ccccc3n4-c3ccccc3)n2)cc1]

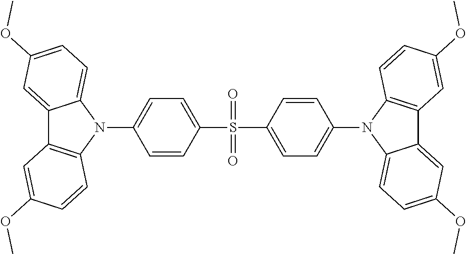 [SMILES: COc1ccc2c(c1)c1cc(OC)ccc1n2-c1ccc(S(=O)(=O)c2ccc(-n3c4ccc(OC)cc4c4cc(OC)ccc43)cc2)cc1]

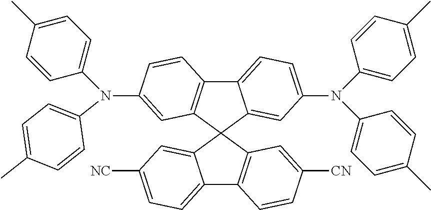

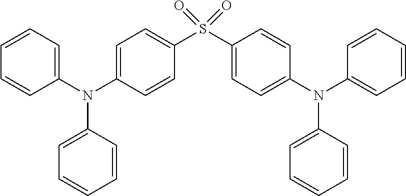 [SMILES: O=S(=O)(c1ccc(N(c2ccccc2)c2ccccc2)cc1)c1ccc(N(c2ccccc2)c2ccccc2)cc1]

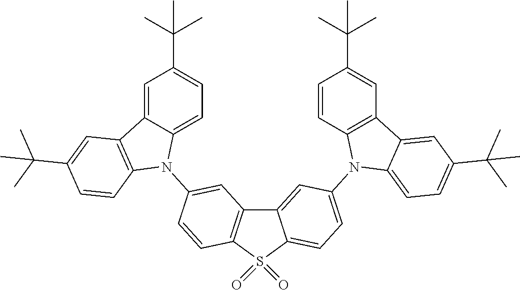 [SMILES: CC(C)(C)c1ccc2c(c1)c1cc(C(C)(C)C)ccc1n2-c1ccc2c(c1)-c1cc(-n3c4ccc(C(C)(C)C)cc4c4cc(C(C)(C)C)ccc43)ccc1S2(=O)=O]

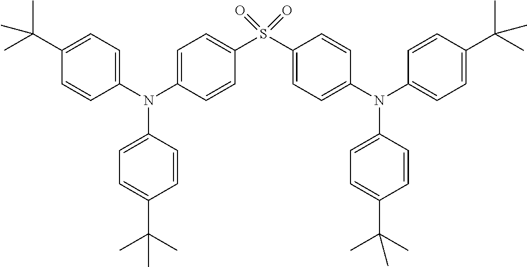 [SMILES: CC(C)(C)c1ccc(N(c2ccc(C(C)(C)C)cc2)c2ccc(S(=O)(=O)c3ccc(N(c4ccc(C(C)(C)C)cc4)c4ccc(C(C)(C)C)cc4)cc3)cc2)cc1]

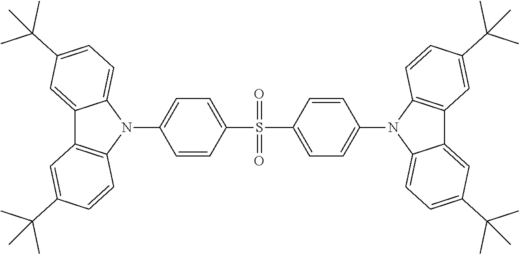 [SMILES: CC(C)(C)c1ccc2c(c1)c1cc(C(C)(C)C)ccc1n2-c1ccc(S(=O)(=O)c2ccc(-n3c4ccc(C(C)(C)C)cc4c4cc(C(C)(C)C)ccc43)cc2)cc1]

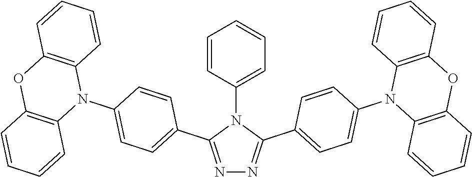 [SMILES: c1ccc(-n2c(-c3ccc(N4c5ccccc5Oc5ccccc54)cc3)nnc2-c2ccc(N3c4ccccc4Oc4ccccc43)cc2)cc1]

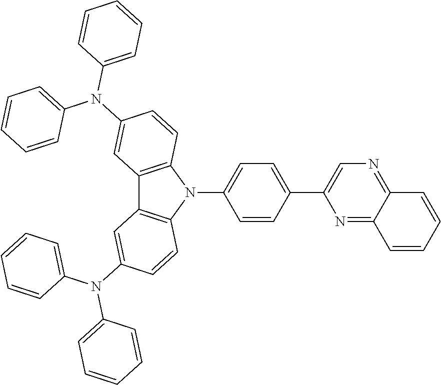 [SMILES: c1ccc(N(c2ccccc2)c2ccc3c(c2)c2cc(N(c4ccccc4)c4ccccc4)ccc2n3-c2ccc(-c3cnc4ccccc4n3)cc2)cc1]

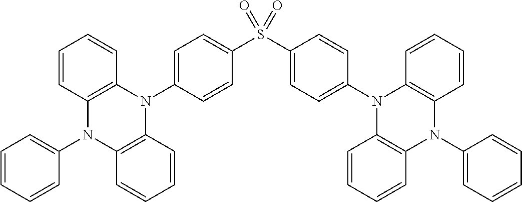 [SMILES: O=S(=O)(c1ccc(N2c3ccccc3N(c3ccccc3)c3ccccc32)cc1)c1ccc(N2c3ccccc3N(c3ccccc3)c3ccccc32)cc1]

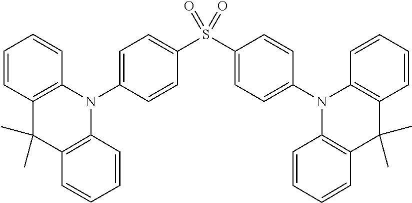

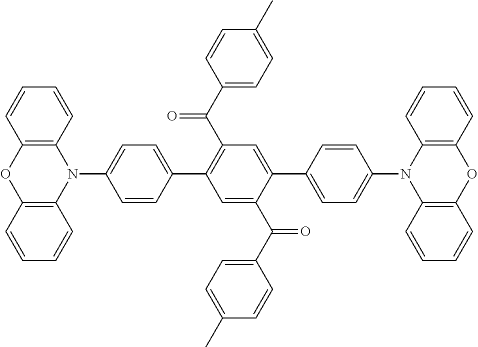 [SMILES: Cc1ccc(C(=O)c2cc(-c3ccc(N4c5ccccc5Oc5ccccc54)cc3)c(C(=O)c3ccc(C)cc3)cc2-c2ccc(N3c4ccccc4Oc4ccccc43)cc2)cc1]

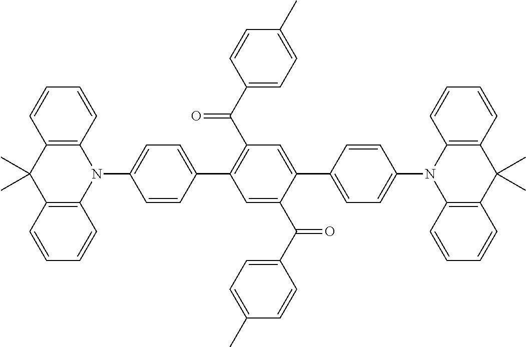

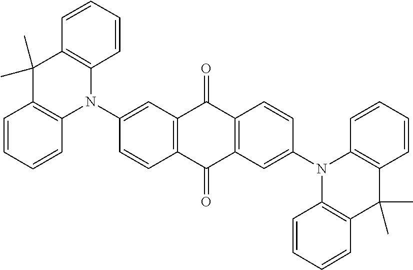

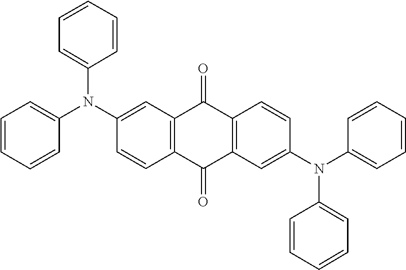 [SMILES: O=C1c2ccc(N(c3ccccc3)c3ccccc3)cc2C(=O)c2ccc(N(c3ccccc3)c3ccccc3)cc21]

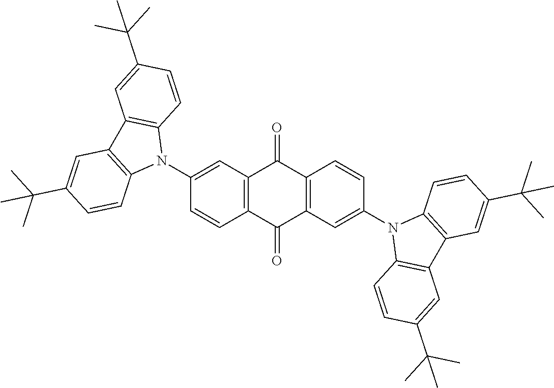 [SMILES: CC(C)(C)c1ccc2c(c1)c1cc(C(C)(C)C)ccc1n2-c1ccc2c(c1)C(=O)c1ccc(-n3c4ccc(C(C)(C)C)cc4c4cc(C(C)(C)C)ccc43)cc1C2=O]

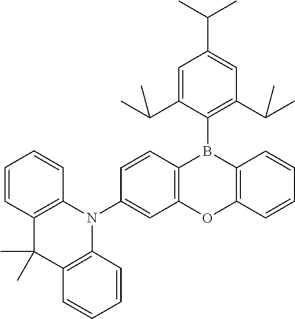 [SMILES: CC(C)c1cc(C(C)C)c(B2c3ccccc3Oc3cc(N4c5ccccc5C(C)(C)c5ccccc54)ccc32)c(C(C)C)c1]

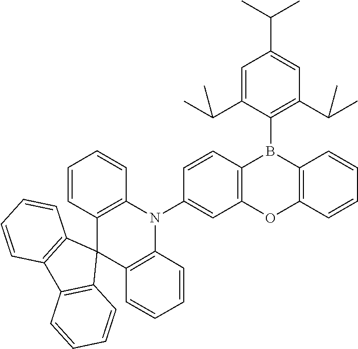 [SMILES: CC(C)c1cc(C(C)C)c(B2c3ccccc3Oc3cc(N4c5ccccc5C5(c6ccccc6-c6ccccc65)c5ccccc54)ccc32)c(C(C)C)c1]

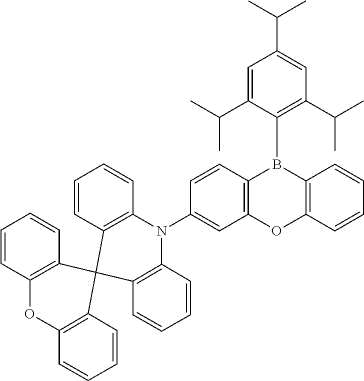 [SMILES: CC(C)c1cc(C(C)C)c(B2c3ccccc3Oc3cc(N4c5ccccc5C5(c6ccccc6Oc6ccccc65)c5ccccc54)ccc32)c(C(C)C)c1]

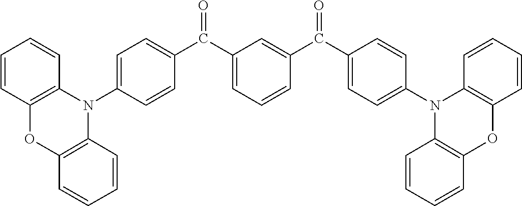 [SMILES: O=C(c1ccc(N2c3ccccc3Oc3ccccc32)cc1)c1cccc(C(=O)c2ccc(N3c4ccccc4Oc4ccccc43)cc2)c1]

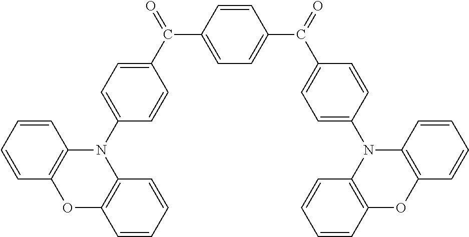 [SMILES: O=C(c1ccc(C(=O)c2ccc(N3c4ccccc4Oc4ccccc43)cc2)cc1)c1ccc(N2c3ccccc3Oc3ccccc32)cc1]

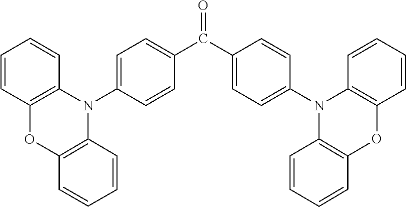 [SMILES: O=C(c1ccc(N2c3ccccc3Oc3ccccc32)cc1)c1ccc(N2c3ccccc3Oc3ccccc32)cc1]

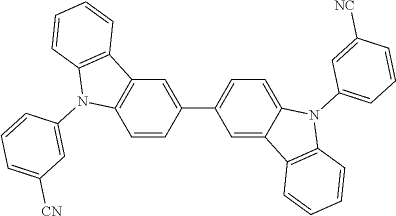 [SMILES: N#Cc1cccc(-n2c3ccccc3c3cc(-c4ccc5c(c4)c4ccccc4n5-c4cccc(C#N)c4)ccc32)c1]

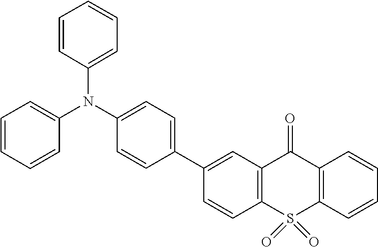 [SMILES: O=C1c2ccccc2S(=O)(=O)c2ccc(-c3ccc(N(c4ccccc4)c4ccccc4)cc3)cc21]

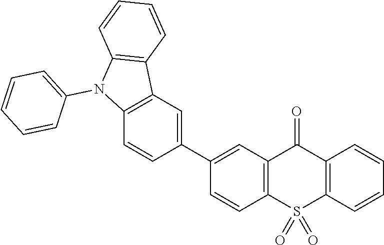 [SMILES: O=C1c2ccccc2S(=O)(=O)c2ccc(-c3ccc4c(c3)c3ccccc3n4-c3ccccc3)cc21]

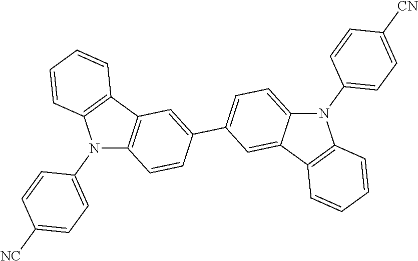 [SMILES: N#Cc1ccc(-n2c3ccccc3c3cc(-c4ccc5c(c4)c4ccccc4n5-c4ccc(C#N)cc4)ccc32)cc1]

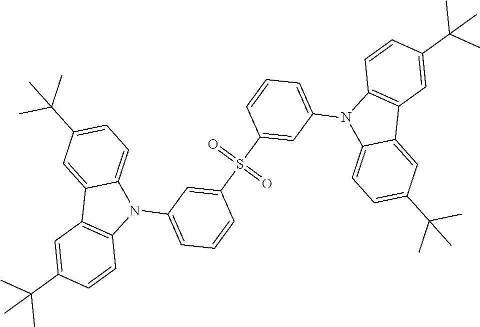 [SMILES: CC(C)(C)c1ccc2c(c1)c1cc(C(C)(C)C)ccc1n2-c1cccc(S(=O)(=O)c2cccc(-n3c4ccc(C(C)(C)C)cc4c4cc(C(C)(C)C)ccc43)c2)c1]

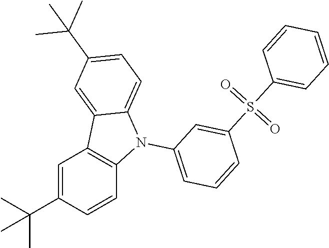 [SMILES: CC(C)(C)c1ccc2c(c1)c1cc(C(C)(C)C)ccc1n2-c1cccc(S(=O)(=O)c2ccccc2)c1]

6. Triplet Emitter

The triplet emitter is also called a phosphorescent emitter. In an exemplary embodiment, the triplet emitter may be a metal complex of the general formula M (L) n, wherein M may be a metal atom; L may be a same or different ligand each time it is present, and may be bonded or coordinated to the metal atom M at one or more positions; n may be an integer greater than 1, for example 1, 2, 3, 4, 5 or 6. Alternatively, these metal complexes may be attached to a polymer by one or more positions, such as through an organic ligand.

In an exemplary embodiment, the metal atom M may be selected from the group consisting of transition metal elements or lanthanides or actinides, for example Ir, Pt, Pd, Au, Rh, Ru, Os, Sm, Eu, Gd, Tb, Dy, Re, Cu or Ag, and particularly preferably Os, Ir, Ru, Rh, Re, Pd, or Pt.

In an embodiment, the triplet emitter comprises a chelating ligand, i.e., a ligand, coordinated to the metal by at least two bonding sites, and it is particularly suitable that the triplet emitter comprises two or three identical or different bidentate or multidentate ligand. Chelating ligands help to improve stability of metal complexes.

Examples of organic ligands may be selected from the group consisting of phenylpyridine derivatives, 7,8-benzoquinoline derivatives, 2 (2 -thienyl) pyridine derivatives, 2 (1-naphthyl) pyridine derivatives, or 2 phenylquinoline derivatives. All of these organic ligands may be optionally substituted, for example, optionally substituted with fluoromethyl or trifluoromethyl. The auxiliary ligand may be, for example, selected from acetylacetonate or picric acid.

In an exemplary embodiment, the metal complex which may be used as the triplet emitter may have the following form:

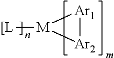

wherein M is a metal selected from the group consisting of transition metal elements or lanthanides or actinides;

Ar¹ may be the same or different cyclic group each time it is present, which comprises at least one donor atom, that is, an atom with a lone pair of electrons, such as nitrogen atom or phosphorus atom, which is coordinated to the metal through its ring group; Ar² may be the same or different cyclic group comprising at least one C atom and is coordinated to the metal through its ring group; Ar¹ and Ar² are covalently bonded together, wherein each of them may carry one or more substituents which may also be joined together by substituents; L may be the same or different at each occurrence and is an auxiliary ligand, for example a bidentate chelating ligand, such as a monoanionic bidentate chelating ligand; m is 1, 2 or 3, for example 2 or 3, and particularly, for example, 3; and, N is 0, 1, or 2, for example 0 or 1, particularly, for example, 0.

Examples of triplet emitter materials and examples of applications thereof may be found in the following patent documents and references: WO 200070655, WO 200141512, WO 200202714, WO 200215645, EP 1191613, EP 1191612, EP 1191614, WO 2005033244, WO 2005019373, US 2005/0258742, WO 2009146770, WO 2010015307, WO 2010031485, WO 2010054731, WO 2010054728, WO 2010086089, WO 2010099852, WO 2010102709, US 20070087219 Al, US 20090061681 A1, US 20010053462 A1, Baldo, Thompson et al. Nature 403, (2000), 750-753, US 20090061681 A1, US 20090061681 A1, Adachi et al. Appl. Phys. Lett.78 (2001), 1622-1624, J. Kido et al. Appl. Phys. Lett.65 (1994), 2124, Kido et al. Chem. Lett. 657, 1990, US 2007/0252517 A1, Johnson et al., JACS 105, 1983, 1795, Wrighton, JACS 96, 1974, 998, Ma et al., Synth. Metals 94, 1998, 245, U.S. Pat. No. 6,824,895, U.S. Pat. No. 7,029,766, U.S. Pat. No. 6,835,469, U.S. Pat. No. 6,830,828, US 20010053462 A1, WO 2007095118 A1, US 2012004407A1, WO 2012007088A1, WO2012007087A1, WO 2012007086A1, US 2008027220A1, WO 2011157339A1, CN 102282150A, and WO 2009118087A1. The entire contents of the above listed patent or literature documents are hereby incorporated by reference.

Examples of suitable triplet emitter are given in the following table:

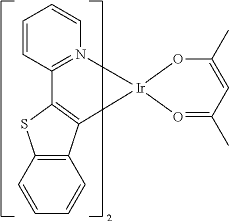

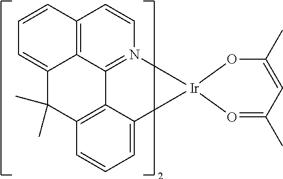

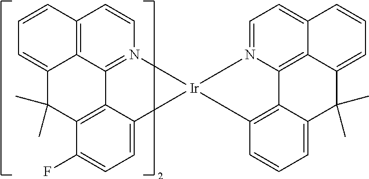

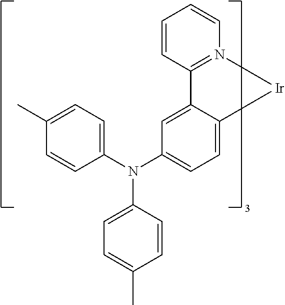

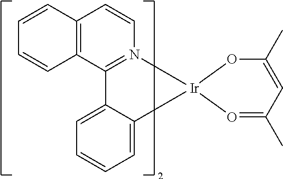

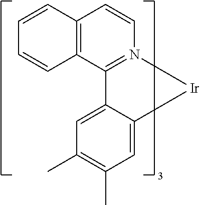

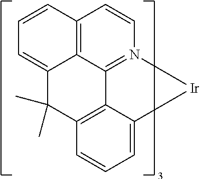

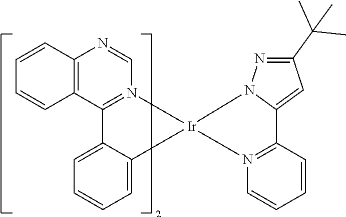

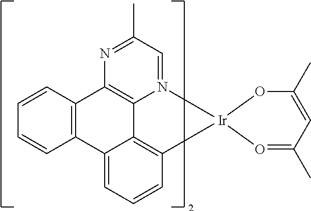

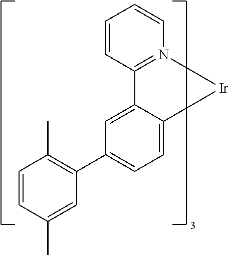

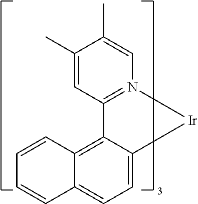

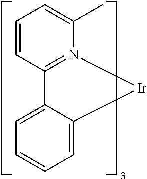

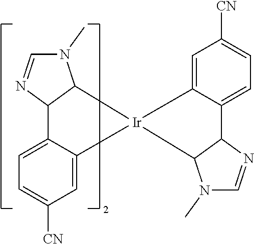

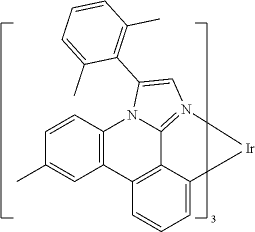

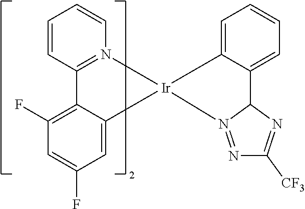

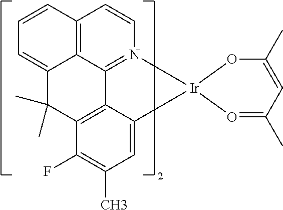

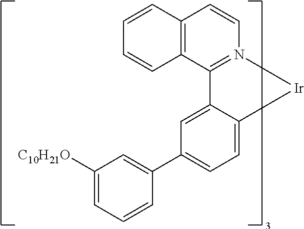

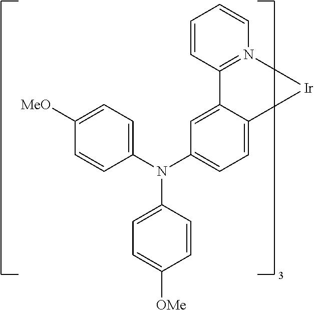

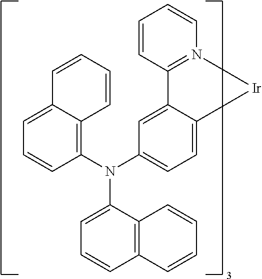

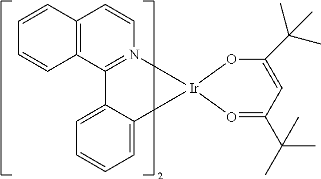

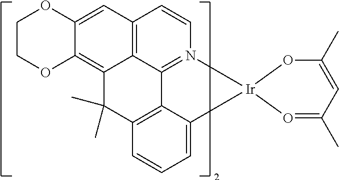

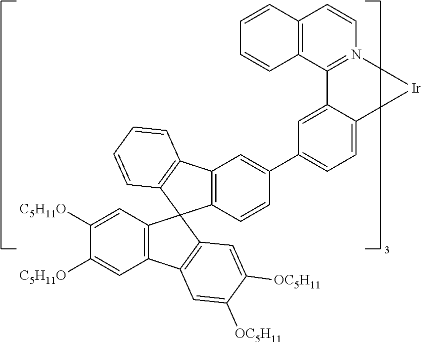

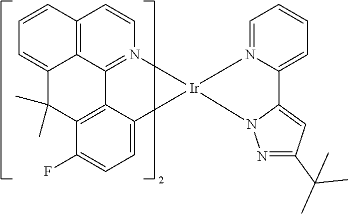

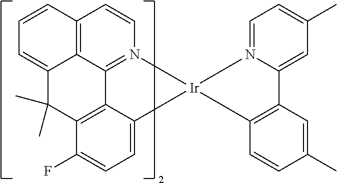

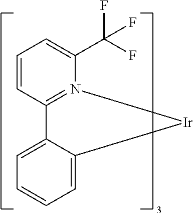

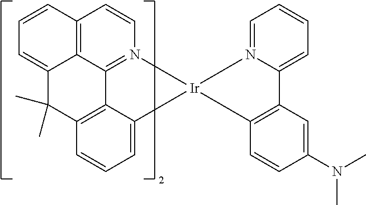

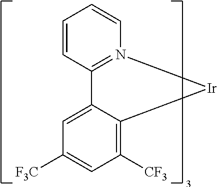

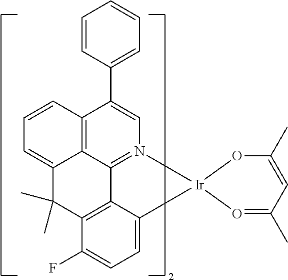

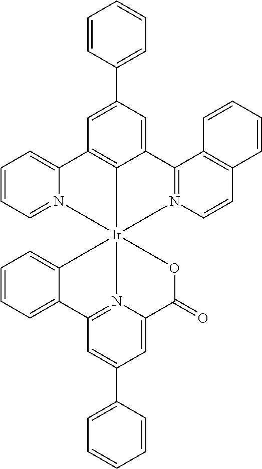

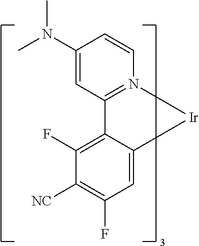

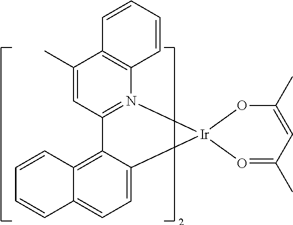

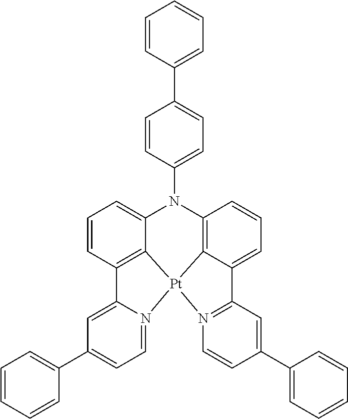

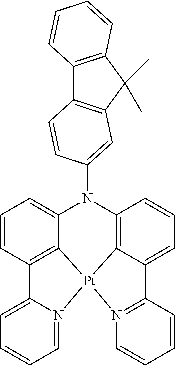

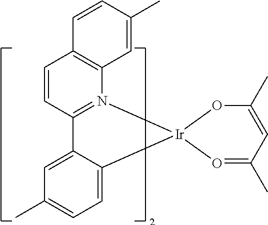

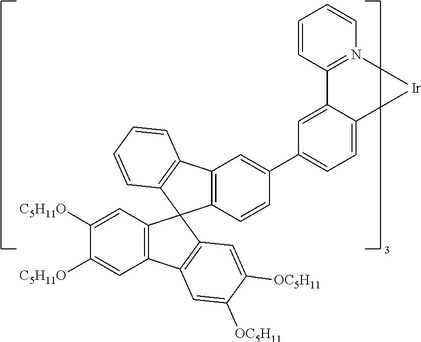

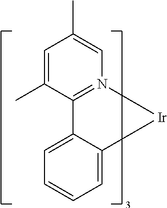

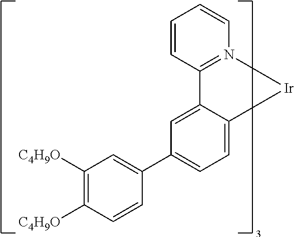

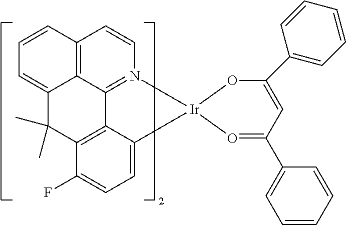

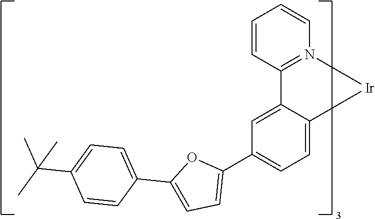

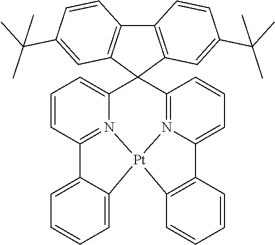

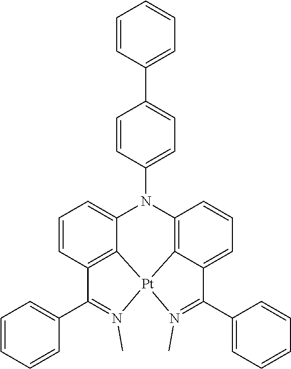

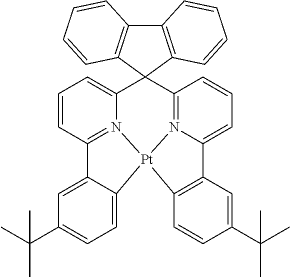

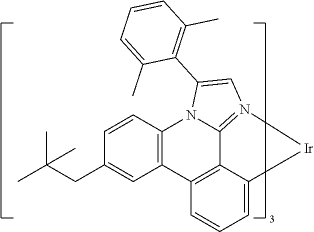

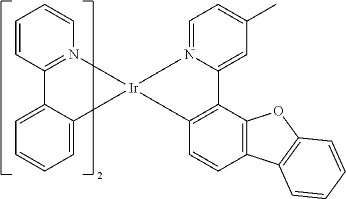

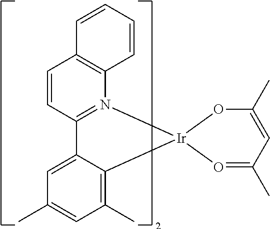

In another exemplary embodiment, the functional material comprised in the formulation according to the disclosure is a polymer material.

In general, the organic small-molecule functional materials described above, including HIM, HTM, ETM, EIM, Host, fluorescent emitters, phosphorescent emitters, and TADF, which may be comprised as a repeating unit in a polymer.

In an exemplary embodiment, the polymer suitable for the present disclosure is a conjugated polymer. In general, the conjugated polymers have the following general formula:

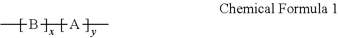

wherein B and A can be independently selected from the same or different structural units when present in multiple occurrences;

B: π-conjugated structural unit with a relatively large energy gap, also called a backbone unit, which may be selected from monocyclic or polycyclic aryl or heteroaryl groups. An exemplary unit form is benzene, biphenylene, naphthalene, anthracene, phenanthrene, dihydrophenanthrene, 9,10-dihydrophenanthrene, fluorene, bifluorene, spirobifluorene, p-phenylacetylene, trans- indenofluorene, cis- indenofluorene, dibenzoindenofluorene, indenonaphthalene, and the derivatives thereof;

A: π-conjugated structural unit with a small energy gap, also called a functional unit, which may be selected from structural units comprising the hole injection or transport material (HIM/HTM), electron injection or transport material (EIM/ETM), host material, singlet emitter (fluorescent emitter), and heavy emitter (phosphor emitter) mentioned above according to different functional requirements; and

x, y: >0, and x+y=1.

In some exemplary embodiments, the functional material comprised in the formulation according to the present disclosure is a polymeric HTM.

In an exemplary embodiment, the polymeric HTM material is a homopolymer, and exemplary homopolymers are selected from the group consisting of polythiophenes, polypyrroles, polyanilines, polybiphenyl triarylamines, polyvinylcarbazoles, and derivatives thereof.

In another particularly suitable embodiment, the polymeric HTM material is a conjugated copolymer represented by Chemical Formula 1, wherein

A: a functional group having hole transporting ability, which may be selected from the same or different structural units comprising the hole injection or transport material (HIM/HTM) described above; in an exemplary embodiment, A is selected from the group consisting of amines, biphenyl triarylamines, thiophene, thiothiophenes such as dithienothiophene and thiothiophene, pyrrole, aniline, carbazole, indenocarbazole, indolizine-diphenyleneimide, pentacene, phthalocyanine, porphyrin and the derivative thereof; and

x,y: >0, and x+y=1; usually y≥0.10, such as ≥0.15, for example ≥0.20, such as x=y=0.5.

Listed below are examples of suitable conjugated polymers that can be used as HTMs:

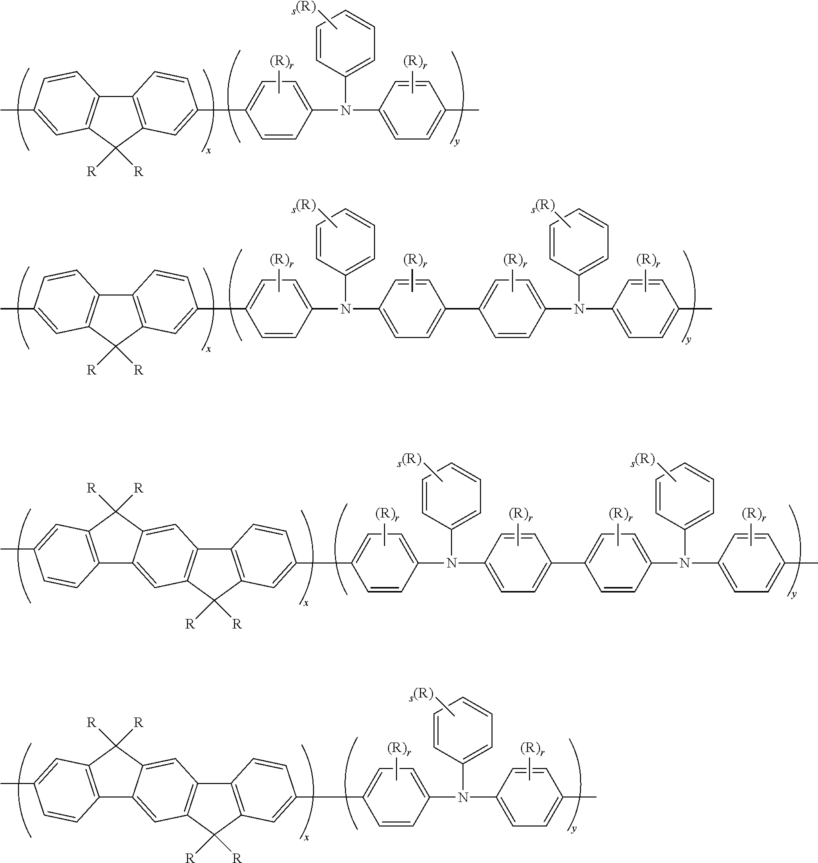

wherein,

R is each independently selected from a linear alkyl, alkoxy, or thioalkoxy having 1 to 20 C atoms; or a branched or cyclic alkyl, alkoxy or thioalkoxy group, or silyl group having 3 to 20 C atoms; or a substituted ketone group having 1 to 20 C atoms; or an alkoxy group having 2 to 20 C atoms; or an aryloxycarbonyl having 7 to 20 C atoms, cyano (—CN), carbamoyl(—C(═O)NH₂), haloformyl (—C(═O)—X, wherein X represents a halogen atom), formyl (—C(═O)—H), isocyano, isocyanate, thiocyanate, or isothiocyanate, hydroxy, nitro, CF₃, Cl, Br, and F; a crosslinkable group or a substituted or unsubstituted aromatic or heteroaromatic ring system having 5 to 40 annular atoms; or an aryloxy group or heteroaryloxy group having 5 to 40 annular atoms, or a combination thereof, wherein one or more of the group R may form a monocyclic or polycyclic aliphatic or aromatic ring system with each other and/or with a ring bonded to said groups;

r is 0, 1, 2, 3 or 4;

s is 0, 1, 2, 3, 4 or 5; and

x,y: >0, and x+y=1; usually y≥0.10, for example y≥0.15, for example y≥0.20, such as x=y=0.5.

Another exemplary class of organic functional materials are polymers having electron transport capabilities, including conjugated polymers and non-conjugated polymers.

Exemplary polymer ETM material is a homopolymer, with exemplary homopolymers selected from the group consisting of polyphenanthrene, polyphenanthroline, polyindenofluorene, polyspirobifluorene, polyfluorene, and the derivatives thereof.

The exemplary polymer ETM material is the conjugated copolymer represented by Chemical Formula 1, wherein A can be independently selected in the same or different forms in multiple occurrences:

A: a functional group with electron transport capability, for example selected from tris(8-hydroxyquinoline) aluminum (AlQ₃), benzene, diphenylene, naphthalene, anthracene, phenanthrene, dihydrophenanthrene, fluorene, bifluorene, spirobifluorene, p-phenylene acetylene, pyrene, perylene, 9,10-dihydrophenanthrene, phenazine, phenanthroline, trans- indenofluorene, cis- indenofluorene, dibenzo-indenofluorene, indenaphthalene, benzopyrene and the derivatives thereof; and

x,y: >0, and x+y=1; usually y≥0.10, for example y≥0.15, for example y≥0.20, such as x=y=0.5.

In another exemplary embodiment, the functional material comprised in the formulation according to the disclosure is a light-emitting polymer.

In a particularly suitable embodiment, the light-emitting polymer is a conjugated polymer having the following general formula:

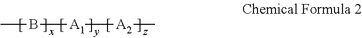

B: having the same as the definition as in Chemical Formula 1;

A1: a functional group with hole or electron transport capability, which may be selected from structural units comprising the hole injection or transport material (HIM/HTM) or electron injection or transport material (EIM/ETM) described above;

A2: a group with a light-emitting function, which may be selected from structural units comprising singlet emitters (fluorescent emitters) and heavy emitters (phosphor emitters) as described above; and

x,y,z: >0, and x+y+z=1.

Examples of light-emitting polymers are disclosed in the following patent applications: WO2007043495, WO2006118345, WO2006114364, WO2006062226, WO2006052457, WO2005104264, WO2005056633, WO2005033174, WO2004113412, WO2004041901, WO2003099901, WO2003051092, WO2003020790, WO2003020790, US2020040076853, US2020040002576, US2007208567, US2005962631, EP201345477, EP2001344788, DE102004020298, the entire contents of the above patent documents being incorporated herein by reference.

In another embodiment, the polymer suitable for the present disclosure is a non-conjugated polymer. It may be a polymer with a non-conjugated main chian and a side chain havingt all functional groups. Some of such non-conjugated polymers used as phosphorescent host or phosphorescent materials are disclosed in patent applications such as U.S. Pat. No. 7,250,226 B2, JP2007059939A, JP2007211243A2, and JP2007197574A2, and some such non-conjugated polymers used as fluorescent materials are disclosed in patent applications such as JP2005108556, JP2005285661 and JP2003338375. In addition, the non-conjugated polymer may also be a polymer with functional units on the main chain being linked by non-conjugated linking units. Examples of such polymers are disclosed in, for example, DE102009023154.4 and DE102009023156.0. The entire contents of the above patent documents are hereby incorporated by reference.

The present disclosure also relates to a method for preparing a thin film comprising a functional material by a printing or coating method, wherein any one of the above-mentioned formulations is coated on a substrate by a printing or coating method, wherein the coating method may be selected from (but not limited to) ink-jet printing, nozzle printing, typography, screen printing, dip coating, spin coating, blade coating, roll printing, torsion printing, lithography, flexography, rotary printing, spray printing, brush coating, pad printing, or slit type extrusion coating, and the like

In an exemplary embodiment, the film comprising the functional material is prepared by a method of ink jet printing. Inkjet printers that can be used to print with the inks in accordance with the present disclosure are commercially available printers and include drop-on-demand printheads. These printers are available from Fujifilm Dimatix (Lebanon, N.H.), Trident International (Brookfield, Conn.), Epson (Torrance, Calif.), Hitachi Data Systems Corporation (Santa Clara, Calif.), Xaar PLC (Cambridge, United Kingdom), and Idanit Technologies, Limited (Rishon Le Zion, Isreal). For example, the present disclosure can be printed using a Dimatix Materials Printer DMP-3000 (Fujifilm).

The disclosure further relates to an electronic device comprising one or more functional films, wherein at least one functional film is produced using a printing ink formulation according to the disclosure, in particular by printing or coating.

Suitable electronic devices include, but are not limited to, quantum dot light emitting diodes (QLEDs), quantum dot photovoltaic cells (QPVs), quantum dot light emitting electrochemical cells (QLEECs), quantum dot field effect transistors (QFETs), quantum dot light emitting field effect transistors, quantum dot lasers, quantum dot sensors, organic light emitting diodes (OLEDs), organic photovoltaic cells (OPVs), organic light emitting electrochemical cells (OLEECs), organic field effect transistors (OFETs), organic light emitting field effect transistors, organic lasers, organic sensors, and the like.

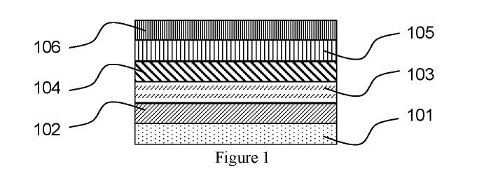

In an exemplary embodiment, the electronic device described above is an electroluminescent device or a photovoltaic cell, as shown in FIG. 1, comprising a substrate (101), an anode (102), at least a light emitting layer or a light absorption layer (104), and a cathode (106). Now further illustration will be provided below using electroluminescent device only as an example.

The substrate (101) may be opaque or transparent. A transparent substrate can be used to make a transparent light emitting device. See, for example, Bulovic et al. Nature 1996, 380, p29, and Gu et al., Appl. Phys. Lett. 1996, 68, p2606. The substrate can be rigid or elastic. The substrate can be plastic, metal, semiconductor wafer or glass. Preferably the substrate has a smooth surface. Substrate-free substrate is a particularly good choice. In an exemplary embodiment, the substrate may be selected from a polymer or plastic film having a glass transition temperature Tg of 150° C. or above, for example 200° C. or above, for example 250° C. or above, such as 300° C. or above. Examples of suitable substrates are poly(ethylene terephthalate) (PET) and polyethylene glycol (2,6-naphthalene) (PEN).

The anode (102) may include a conductive metal or metal oxide, or a conductive polymer. The anode can easily inject holes into the HIL or HTL or the light emitting layer. In one embodiment, the absolute value of the difference between the work function of the anode and the HOMO level or valence band level of the p-type semiconductor material as HIL or HTL is less than 0.5 eV, for example less than 0.3 eV, such as less than 0.2 eV. Examples of anode materials include, but are not limited to, Al, Cu, Au, Ag, Mg, Fe, Co, Ni, Mn, Pd, Pt, ITO, aluminum doped zinc oxide (AZO), and the like. Other suitable anode materials are known and can be readily selected by one of ordinary skill in the art. The anode material may be deposited using any suitable technique, such as a suitable physical vapor deposition method including radio frequency magnetron sputtering, vacuum thermal evaporation, e-beam, and the like.

In certain embodiments, the anode is patterned. Patterned ITO conductive substrates are commercially available and can be used to make devices according to the present disclosure.

The cathode (106) may include a conductive metal or metal oxide. The cathode can easily inject electrons into the EIL or ETL or directly into the light emitting layer. In one embodiment, the absolute value of the difference between the work function of the cathode and the LUMO level or the conduction band level of the n-type semiconductor material as EIL or ETL or HBL is less than 0.5 eV, for example less than 0.3 eV, such as less than 0.2 eV. In principle, all materials that can be used as cathodes for OLEDs are possible as cathode materials for the devices of the disclosure. Examples of cathode materials include, but are not limited to, Al, Au, Ag, Ca, Ba, Mg, LiF/Al, MgAg alloys, BaF₂/Al, Cu, Fe, Co, Ni, Mn, Pd, Pt, ITO, and the like. The cathode material may be deposited using any suitable technique, such as a suitable physical vapor deposition method including radio frequency magnetron sputtering, vacuum thermal evaporation, e-beam, and the like.

The light emitting layer (104) contains at least one light emitting functional material, and its thickness may be between 2 nm and 200 nm. In an exemplary embodiment, in the light emitting device according to the present disclosure, the light emitting layer is prepared by printing with the printing ink of the present disclosure, wherein the printing ink comprises at least one kind of the light emitting functional materials as described above, especially the quantum dots or organic functional materials.

In an exemplary embodiment, the light-emitting device according to the present disclosure further comprises a hole injection layer (HIL) or hole transport layer (HTL) (103), which comprises theorganic HTM or inorganic p-type material as described above. In an exemplary embodiment, the HIL or HTL can be prepared by printing with the printing ink of the present disclosure, wherein the printing ink comprises a functional material having a hole transporting ability, particularly a quantum dot or an organic HTM material.

In another exemplary embodiment, the light emitting device according to the present disclosure further comprises an electron injection layer (EIL) or electron transport layer (ETL) (105) that comprises an organic ETM or inorganic n-type material as described above. In certain embodiments, the EIL or ETL can be prepared by printing with a printing ink of the present disclosure, wherein the printing ink comprises a functional material having electron transport capabilities, particularly quantum dot or organic ETM materials.

The present disclosure also relates to the use of the light emitting device according to the present disclosure in various applications including, but not limited to, various display devices, backlights, illumination sources, and the like.

The present disclosure will be described below with reference to following exemplary embodiments, but is not limited thereto. It should be understood that the scope of the present disclosure is defined by the appended claims. Those skilled in the art will appreciate that, guided by the concept of the present disclosure, various modifications can be made to the embodiments of the disclosure, without departing from the spirit and scope of the disclosure as claimed.

### EXAMPLE 1

### Preparation of Blue-Light Quantum Dots (CdZnS/ZnS)

0.0512 g of S and 2.4 mL ODE were weighed in a 25 mL single-mouth flask, heated to 80° C. in an oil bath to dissolve S for later use (refered to as Solution 1 hereinafter). 0.1280 g of S and 5 mL of OA were weighed in a 25 mL single-mouth flask heated to 90° C. in an oil bath to dissolve S for later use (refered to as Solution 2 hereinafter). 0.1028 g of CdO, 1.4680 g of zinc acetate, and 5.6 mL of OA were weighed in a 50 mL three-necked flask, which was then placed in a 150-mL heating mantle, had both openingsstoppered with a rubber stopper, and was connected to a condensing tube at the top. The tube was then connected to a double-barreled tube. The mixture was heated to 150° C., vacuumed for 40 minutes, and then purged with nitrogen. A syringe was used to add 12 mL of ODE to the three-necked flask, which was heated to a temperature of 310° C., when 1.92 mL of Solution 1 was rapidly injected into the three-necked flask with a syringe and timed for 12 min. After 12 minutes, 4 mL of Solution 2 was added dropwise to the three-necked flask with a syringe at about 0.5 mL/min. The reaction went on for 3 h and then stopped. The three-necked flask was immediately put into water and cooled to 150° C.

An excessive amount of n-hexane was added to the three-necked flask, then the liquid in the three-necked flask was transferred to a plurality of 10 mL centrifuge tubes, centrifuged to remove the lower precipitate and repeated three times. The post-treated liquid was added with acetone until precipitation, centrifuged to remove the supernatant, with a precipitate remaining. The precipitate was then dissolved with n-hexane, added with acetone to precipitate, and centrifuges to remove the supernatant, leaving a precipitate behind. These steps were repeated for three times. Finally, the precipitate was dissolved in toluene and transferred to a glass bottle for storage.

### EXAMPLE 2

### Preparation of Green Light Quantum Dots (CdZnSeS/ZnS)

0.0079 g of selenium and 0.1122 g of sulphur were weighed in a 25 mL single-mouth flask, added with 2 mL of TOP, purged with nitrogen, and stirred for later use (refered to as Solution 1 hereinafter). 0.0128 g of CdO, 0.3670 g of zinc acetate, and 2.5 mL of OA were weighed in a 25 mL three-necked flask, which then had both openings stoppered with a rubber stopper, and was connected to a condensing tube at the top. The tube was then connected to a double-barreled tube. The three-neck flask was placed in a 50 mL heating mantle, vacuumed, purged with nitrogen, heated to 150° C., vacuumed for 30 minutes, injected with 7.5 mL of ODE, heated to 300° C., rapidly injected with 1 mL of Solution 1, and timed for 10 min. After 10 minutes, the reaction was stopped immediately. The three-necked flask was put into water for cooling.

To the three-necked flask was added 5 mL of n-hexane, and then the mixture was added to a plurality of 10 mL centrifuge tubes, added with acetone until precipitation, and centrifuged. The precipitate was taken, and the supernatant was removed. The precipitate was dissolved with n-hexane, added with acetone until a precipitate was formed, and centrifuged. These steps were repeated for three times. The final precipitate was dissolved with a small amount of toluene and transferred to a glass bottle for storage.

### EXAMPLE 3

### Preparation of Red Light Quantum Dots (CdSe/CdS/ZnS)

1 mmol of CdO, 4 mmol of OA and 20 ml of ODE were added to a 100 ml three-necked flask, purged with nitrogen, heated to 300° C. to form a Cd(OA)₂ precursor. At this temperature, 0.25 mL of TOP with 0.25 mmol Se dissolved was rapidly injected. The reaction solution was allowed to react at this temperature for 90 seconds, and a CdSe core of about 3.5 nm was grown. 0.75 mmol of octanethiol was added dropwise to the reaction solution at 300° C. After about 30 minutes of reaction, a CdS shell about 1 nm thick was grown. 4 mmol of Zn(OA)₂ and 2 ml of TBP dissolved with 4 mmol of S powder were then added dropwise to the reaction solution to grow a ZnS shell (about 1 nm). The reaction was continued for 10 minutes and cooled to room temperature.

To the three-necked flask was added 5 mL of n-hexane, and then the mixture was added to a plurality of 10 mL centrifuge tubes, added with acetone until precipitation, and centrifuged. The precipitate was taken, and the supernatant was removed. The precipitate was dissolved with n-hexane, added with acetone until a precipitate was formed, and centrifuged. These steps were repeated for three times. The final precipitate was dissolved with a small amount of toluene and transferred to a glass bottle for storage.

### EXAMPLE 4

### Preparation of ZnO Nanoparticles

1.475 g of zinc acetate was dissolved in 62.5 mL of methanol to obtain Solution 1. 0.74 g KOH was dissolved in 32.5 mL of methanol to give solution 2. Solution 1 was heated to 60° C. and stirred vigorously. Solution 2 was added dropwise to solution 1 using a sample injector. After the addition was completed, the mixed solution system was further stirred at 60° C. for 2 hours. The heating source was removed and the solution was allowed to stand for 2 hours. Tthe reaction solution was centrifuged at 4,500 rpm, 5 min and washed for three times or more . The final ZnO nanoparticles were yielded as white solid with a diameter of about 3 nm.

### EXAMPLE 5

### Preparation of Quantum Dot Printing Inks Comprising 3-Phenoxytoluene and Dodecylbenzene

A stirrer was placed in a vial, cleaned and transfered to a glove box. In the vial, 9.5 g of a mixed solvent of 3-phenoxytoluene and dodecylbenzene (weight ratio: 60:40) was prepared. The quantum dots were precipitated from the solution with acetone and centrifuged to obtain the quantum dot solids. 0.5 g of quantum dot solids were weighed in the glove box, added to the solvent system in the vial and mixed by stirring. The quantum dots were stirred at 60° C. until completely dispersed and cooled to room temperature. The resulting quantum dot solution was filtered through a 0.2 μm PTFE filter, sealed for storage.

### EXAMPLE 6

### Preparation of ZnO Nanoparticle Printing Inks Comprising 1-Tetralone and Dodecylbenzene

A stirrer was placed in a vial, cleaned and transfered to a glove box. In the vial, 9.5 g of a mixed solvent of 1-tetralone and dodecylbenzene (weight ratio: 60:40) was prepared. 0.5 g of ZnO quantum dot solids were weighed in the glove box, added to the solvent system in the vial and mixed by stirring. The ZnO quantum dots were stirred at 60° C. until completely dispersed and cooled to room temperature. The resulting ZnO quantum dot solution was filtered through a 0.2 μm PTFE filter, sealed for storage.

The organic functional materials involved in the following examples are all commercially available, such as from Jilin OLED Material Tech Co., Ltd, www.jl-oled.com, or can be synthesized according to a method reported in the literature.

### EXAMPLE 7

### Preparation of Organic light-emitting Layer Material Printing Ink Comprising 3-Phenoxytoluene and Dodecylbenzene

In this embodiment, the organic functional material for the light-emitting layer comprises a phosphorescent host material and a phosphorescent emitter material. The phosphorescent host material is selected from the following carbazole derivatives:

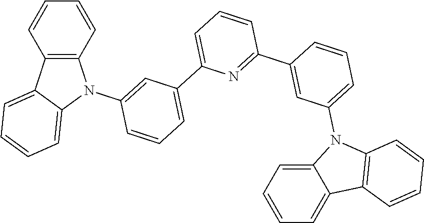 [SMILES: c1cc(-c2cccc(-c3cccc(-n4c5ccccc5c5ccccc54)c3)n2)cc(-n2c3ccccc3c3ccccc32)c1]

The phosphorescent emitter material is selected from the following iridium complexes:

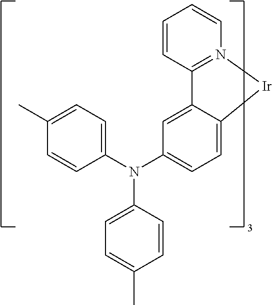

A stirrer was placed in a vial, cleaned and transfered to a glove box. In the vial, 9.8 g of a mixed solvent of 3-phenoxytoluene and dodecylbenzene (weight ratio: 60:40) was prepared. 0.18 g of a phosphorescent host material and 0.02 g of a phosphorescent emitter material were weighed in the glove box, added to the solvent system in the vial and mixed by stirring. The organic functional material was stirred at 60° C. until completely dispersed and cooled to room temperature. The resulting organic functional material solution was filtered through a 0.2 μm PTFE filter, sealed for storage.

### EXAMPLE 8

### Preparation of an Organic Light-emitting Layer Material Printing Ink Containing 3-Phenoxytoluene and Dodecylbenzene

In this embodiment, the organic functional material for light-emitting layer comprises a fluorescent host material and a fluorescent emitter material.

The fluorescent host material is selected from the following spirofluorene derivatives:

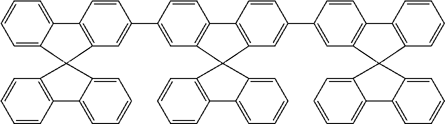 [SMILES: c1ccc2c(c1)CC1(Cc3ccccc3-2)c2ccccc2-c2ccc(-c3ccc4c(c3)C3(Cc5ccccc5-c5ccccc5C3)c3cc(-c5ccc6c(c5)C5(Cc7ccccc7-c7ccccc7C5)c5ccccc5-6)ccc3-4)cc21]

The fluorescent emitter material is selected from the following compounds:

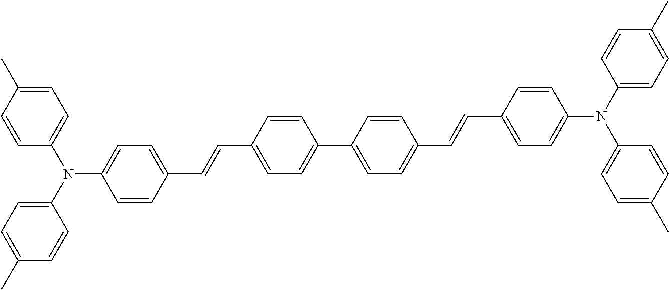 [SMILES: Cc1ccc(N(c2ccc(C)cc2)c2ccc(/C=C/c3ccc(-c4ccc(/C=C/c5ccc(N(c6ccc(C)cc6)c6ccc(C)cc6)cc5)cc4)cc3)cc2)cc1]

A stirrer was placed in a vial, cleaned and transfered to a glove box. In the vial, 9.8 g of a mixed solvent of 3-phenoxytoluene and dodecylbenzene (weight ratio: 60:40) was prepared. 0.19 g of a fluorescent host material and 0.01 g of a fluorescent emitter material were weighed in the glove box, added to the solvent system in the vial and mixed by stirring. The organic functional material were stirred at 60° C. until completely dispersed and cooled to room temperature. The resulting organic functional material solution was filtered through a 0.2 μm PTFE filter, sealed for storage.

### EXAMPLE 9

### Preparation of an Organic Light-emitting Layer Material Printing Ink Containing 3-Phenoxytoluene and Dodecylbenzene

In this embodiment, the organic functional material for light-emitting layer comprises a host material and a TADF material.

The host material is selected from the following compounds:

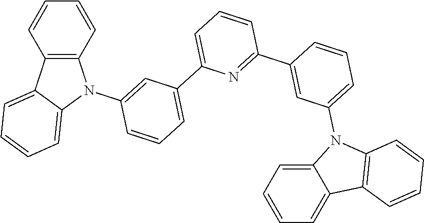 [SMILES: c1cc(-c2cccc(-c3cccc(-n4c5ccccc5c5ccccc54)c3)n2)cc(-n2c3ccccc3c3ccccc32)c1]

The TADF material is selected from the following structures:

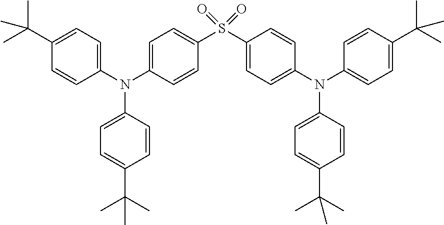 [SMILES: CC(C)(C)c1ccc(N(c2ccc(C(C)(C)C)cc2)c2ccc(S(=O)(=O)c3ccc(N(c4ccc(C(C)(C)C)cc4)c4ccc(C(C)(C)C)cc4)cc3)cc2)cc1]

A stirrer was placed in a vial, cleaned and transfered to a glove box. In the vial, 9.8 g of a mixed solvent of 3-phenoxytoluene and dodecylbenzene (weight ratio: 60:40) was prepared. 0.19 g of a fluorescent host material and 0.01 g of TADF materia were weighed in the glove box, added to the solvent system in the vial and mixed by stirring. The organic functional material were stirred at 60° C. until completely dispersed and cooled to room temperature. The resulting organic functional material solution was filtered through a 0.2 μm PTFE filter, sealed for storage.

### EXAMPLE 10

### Preparation of a Hole Transport Material Printing Ink Comprising 1-Tetralone and Dodecylbenzene

In this embodiment, the printing ink comprises a hole transport layer material having hole transport capability.

The hole transport material is selected from the following triarylamine derivatives:

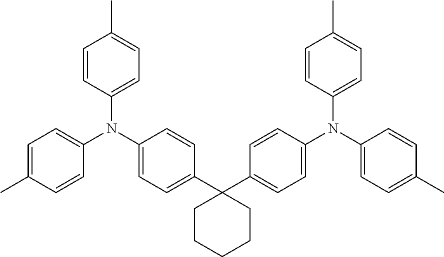

A stirrer was placed in a vial, cleaned and transfered to a glove box. In the vial, 9.8 g of a mixed solvent of 1-tetralone and dodecylbenzene (weight ratio: 60:40) was prepared. 0.2 g of the hole transport material were weighed in the glove box, added to the solvent system in the vial and mixed by stirring. The organic functional material were stirred at 60° C. until completely dispersed and cooled to room temperature. The resulting organic functional material solution was filtered through a 0.2 μm PTFE filter, sealed for storage.

### EXAMPLE 11

### Test of Viscosity and Surface Tension

The viscosity of the quantum dot ink was tested by a DV-I Prime Brookfield rheometer; and the surface tension of the quantum dot ink was tested by a SITA bubble pressure tensiometer.

In the above test, the electron spot ink obtained in Example 5 had a viscosity of 5.4±0.3 cPs and a surface tension of 34.1±0.2 dyne/cm.

In the above test, the electron spot ink obtained in Example 6 has a viscosity of 7.3±0.3 cPs and a surface tension of 36.2±0.1 dyne/cm.

In the above test, the electron spot ink obtained in Example 7 had a viscosity of 5.3±0.3 cPs and a surface tension of 32.3±0.1 dyne/cm.

In the above test, the electron spot ink obtained in Example 8 had a viscosity of 5.5±0.5 cPs and a surface tension of 33.1±0.3 dyne/cm.

In the above test, the electron spot ink obtained in Example 9 had a viscosity of 5.6 ±0.3 cPs and a surface tension of 32.1±0.5 dyne/cm.

In the above test, the electron spot ink obtained in Example 10 had a viscosity of 7.6±0.3 cPs and a surface tension of 33.1±0.2 dyne/cm.

By using the above-prepared printing ink comprising functional materials based on two organic solvent systems, a functional layer in a light emitting diode, such as a light emitting layer and a charge transport layer, can be prepared by ink jet printing. The specific steps are as follows.

The ink comprising the functional material was loaded into an ink tank that is fitted to an inkjet printer such as Dimatix Materials Printer DMP-3000 (Fujifilm). By adjusting the waveform, pulse time, and voltage of the ejected ink, the ink ejection is optimized, and the ink ejection range is stabilized. In the preparation of OLED/QLED devices where the functional material film is a light-emitting layer, the following technical solution is adopted. The substrate of the OLED/QLED is a 0.7 mm-thick glass sputtered with an indium tin oxide (ITO) electrode pattern. The pixel defining layer is patterned on ITO to form holes for depositing printing ink inside. The HIL/HTL material was then ink jet printed into the well and dried under vacuum and elevated temperature to remove the solvent and yield a HIL/HTL film. Thereafter, a printing ink comprising a light-emitting functional material was inkjet printed on the HIL/HTL film, and the solvent was removed under vacuum and elevated temperature to obtain a film of light-emitting layer. Then, the printing ink comprising a functional material with an electron-transporting property was ink-jet printed onto the light-emitting layer film, and the solvent was removed by drying under vacuum and elevated temperature to form an electron transport layer (ETL). When using organic electron transport materials, ETL can also be formed by vacuum thermal evaporation. The Al cathode is then formed by vacuum deposition and finally packaged to complete the preparation of an OLED/QLED device.

Using the printing ink comprising functional materials based on the two organic solvent systems described in the present disclosure, the functional layer film is formed by inkjet printing, which has the beneficial effect of weakening the coffee ring effect. Compared with a printing ink using a single solvent or a printing ink that does not satisfy the dual solvent requirements of the present disclosure, the printing ink comprising the functional material based on the two organic solvent systems of the present disclosure can form a functional layer film with a more flat film surface and more uniform film thickness. Therefore, the OLED/QLED device prepared by the printing ink of the present disclosure has greatly improved device efficiency and lifetime.

The technical features of the above-described embodiments may be combined arbitrarily. For the purpose of conciseness, all the possible combinations of the technical features in the above embodiments are not described. However, as long as there is no contradiction in the combination of these technical features, all should be considered as described in this specification.

The detailed embodiments described herein are only for the purpose of illustrating the present disclosure, and are not intended to limit the scope of the present disclosure in any way. It would be understood by a person skilled in the art that various changes and modifications can be made to the embodiments described herein without departing from the scope and spirit of the present disclosure. Such changes and modifications are contemplated by the present disclosure, the scope of which should only be defined by the following claims.

1. A printing formulation comprising a functional material and a solvent composition, wherein the solvent composition comprises a first solvent and a second solvent, the first solvent having a boiling point T1 less than a boiling point T2 of the second solvent, the first solvent having a surface tension M greater than a surface tension δ2 of the second solvent, wherein δ1−δ2≥2 dyne/cm.

2. The printing formulation according to claim 1, wherein T1≥160° C. and T2−T1 ≥5° C.

3. The printing formulation according to claim 1, wherein T1≥200° C., T2−T1≥20° C., and δ1−δ2≥4 dyne/cm.

4. (canceled)

5. The printing formulation according to claim 1, wherein the first solvent accounts for 50%-80% of the total mass of the solvent composition, and the second solvent accounts for 20%-50% of the total mass of the solvent composition.

6. The printing formulation according to claim 1, wherein the functional material accounts for from 0.3% to 30% of the total mass of the printing formulation, and the solvent composition accounts for from 70% to 99.7% of the total mass of the printing formulation.

7. The printing formulation according to claim 1, wherein both the first solvent and the second solvent have a surface tension in the range of 19 dyne/cm to 50 dyne/cm at 25° C.

8. The printing formulation according to claim 1, wherein both the first solvent and the second solvent have a viscosity in the range of 1 cPs to 100 cPs at 25° C.

9. The printing formulation according to claim 1, wherein the first solvent and the second solvent are each independently selected from aromatic compounds, heteroaromatic compounds, ester compounds, aliphatic ketones or aliphatic ethers.

10. The printing formulation according to claim 9, wherein the first solvent and the second solvent are respectively compounds having the following general formula: 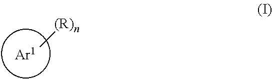
wherein Ar¹ is an aromatic or heteroaromatic ring having 5 to 10 carbon atoms, n ≥1, and R is a substituent.

11. The printing formulation according to claim 10, wherein the general formula I is selected from the following structures: 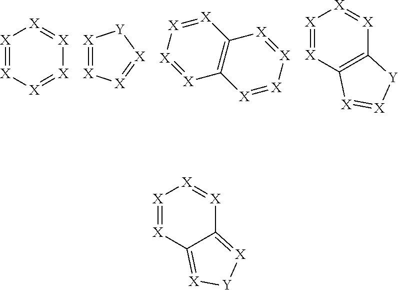
wherein X is CR¹ or N;
Y is selected from CR²R³, SiR⁴R⁵, NR⁶, C═O, S, or O; and
R¹, R², R³, R⁴, R⁵, and R⁶ are each independently selected from: H; D; a linear alkyl, alkoxy, or thioalkoxy having 1 to 20 C atoms; a branched or cyclic alkyl, alkoxy or thioalkoxy group, or silyl group having 3 to 20 C atoms; a substituted ketone group having 1 to 20 C atoms; an alkoxy group having 2 to 20 C atoms; aryloxycarbonyl having 7 to 20 C atoms, cyano, carbamoyl, haloformyl, formyl, isocyano, isocyanate, thiocyanate, or isothiocyanate, hydroxy, nitro, CF₃, Cl, Br, and F; a substituted or unsubstituted aromatic or heteroaromatic ring group having 5 to 40 annular atoms; or an aryloxy group or heteroaryloxy group having 5 to 40 annular atoms.

12. The printing formulation of claim 10, wherein Ar¹ is a group comprising a unit selected from the group consisting of:

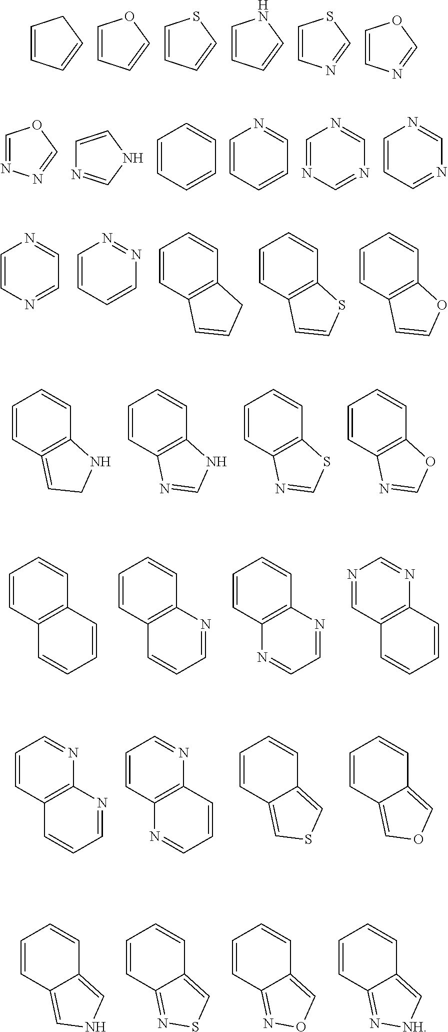

13. The printing formulation according to claim 10, wherein the sub stituent R is selected from: a linear alkyl, alkoxy, or thioalkoxy having 1 to 20 C atoms; or a branched or cyclic alkyl, alkoxy or thioalkoxy group, or silyl group having 3 to 20 C atoms; or a substituted ketone group having 1 to 20 C atoms; an alkoxy group having 2 to 20 C atoms; or an aryloxycarbonyl having 7 to 20 C atoms, cyano, carbamoyl, haloformyl, formyl, isocyano, isocyanate, thiocyanate, or isothiocyanate, hydroxy, nitro, CF₃, Cl, Br, and F; or a substituted or unsubstituted aromatic or heteroaromatic ring group having 5 to 40 annular atoms; or an aryloxy group or heteroaryloxy group having 5 to 40 annular atoms.

14. The printing formulation of claim 9, wherein the first solvent and the second solvent are each independently selected from:
dodecylbenzene, dipentylbenzene, diethylbenzene, trimethylbenzene, tetramethylbenzene, tripentylbenzene, pentyltoluene, 1-methylnaphthalene, dihexylbenzene, dibutylbenzene, p-diisopropylbenzene, phenylpentane, tetrahydronaphthalene, cyclohexylbenzene, chloronaphthalene, 1-tetralone, 3 -phenoxytoluene, 1-methoxynaphthalene, cyclohexylbenzene, dimethylnaphthalene, 3-isopropylbiphenyl, p-methylcumyl, benzyl benzoate, dibenzyl ether or benzyl benzoate.

15. The printing formulation according to claim 9, wherein the first solvent and the second solvent are each independently selected from: alkyl octoates, alkyl sebacates, alkyl stearates, alkyl benzoates, alkyl phenylacetates, alkyl cinnamates, alkyl oxalates, alkyl maleates, alkyl lactones, alkyl oleates, dioctyl ether, triethylene glycol dimethyl ether, fenone, 2,6,8-trimethyl-4-nonanone, acetophenone, benzophenone, butoxybenzene, benzyl butylbenzene or 2,5-dimethoxytoluene.

16. (canceled)

17. The printing formulation according to claim 1, wherein the functional material is a plurality of light-emitting quantum dots with an emission wavelength between 380 nm and 2500 nm.

18. The printing formulation according to claim 17, wherein the light-emitting quantum dots are selected from binary or polybasic semiconductor compounds of Group IV, II-VI, II-V, IV-VI, II-IV-VI, and II-IV-V of the periodic table, or a mixture of these compounds.

19. The printing formulation of claim 1, wherein the functional materials are organic functional materials, which are selected from hole injection materials, hole transport materials, electron transport materials, electron injection materials, electron blocking materials, hole blocking materials, emitters, host materials and organic dyes.

20. The printing formulation according to claim 19, wherein the organic functional material comprises at least one host material and at least one emitter material.

21. (canceled)

22. An electronic device comprising, a functional film prepared la using the printing formulation according to claim 1.

23-24. (canceled)

25. The electronic device according to any one of claims 22-24, characterized in that the electronic device is selected from the group consisting of quantum dot light emitting diodes, quantum dot photovoltaic cells, quantum dot light emitting electrochemical cells, quantum dot field effect transistors, quantum dot light emitting field effect transistors, quantum dot lasers, quantum dot sensors, organic light-emitting diodes, organic photovoltaic cells, organic light-emitting electrochemical cells, organic field effect transistors, organic light-emitting field effect transistors, organic lasers, and organic sensors.
